(19) United States
(12) Patent Application Publication
(10) Pub. No.: US 2016/0162673 A1
(43) Pub. Date: Jun. 9, 2016

(54) TECHNOLOGIES FOR LEARNING BODY PART GEOMETRY FOR USE IN BIOMETRIC AUTHENTICATION

(71) Applicants: Gershom Kutliroff, Mevaseret Tzion (IL); Moti Daniel, Alon Shvut (IL); ALON LERNER, Holon (IL); Mark Kliger, Tel Aviv (IL)

(72) Inventors: Gershom Kutliroff, Mevaseret Tzion (IL); Moti Daniel, Alon Shvut (IL); ALON LERNER, Holon (IL); Mark Kliger, Tel Aviv (IL)

(21) Appl. No.: 14/561,639

(22) Filed: Dec. 5, 2014

(51) Int. Cl. G06F 21/32; G06K 9/62; G06K 9/00

(52) U.S. Cl. CPC G06F 21/32; G06K 9/00013; G06K 9/6255; G06K 9/00268; G06K 9/00087; G06F 2221/2117

(57) ABSTRACT

Technologies for learning body part geometry are described. In some embodiments the technologies include systems, methods and computer readable medium for extracting biometric information from a body part of a user, such as the user's hand. In some instances the extraction is performed with the aid of a calibrated computer model of the body part in question. Body part information may be saved in a data structure for use as a biometric template. The Biometric authentication processes utilizing the technologies are also described.

### BACKGROUND

For security purposes and other reasons electronic devices, systems, and services may be protected by one or more authentication protocols such as a password authentication protocol. In an example password authentication protocol, an individual may supply a username and password to a service provider (e.g., his or her email provider). The service provider may store this information in association with the individual's account. When the individual wishes to access the account, he/she may log in to the service by providing his/her user name and password through a relevant portal such as a website or other application. Similarly, a key code or other type of password may be used to protect one or more rooms or areas from unauthorized access.

Although password authentication protocols are useful, they are becoming increasingly cumbersome as the number of user accounts and the need to use secure (e.g. complex and/or hard to remember) passwords increases. Such protocols also frequently require the storage of a username and password combination on a third party system such as an authentication server. Because authentication servers often store copious amounts of user account information, they may be considered a prime target for attack by malicious software and/or a hacker. If either or both of those entities successfully attack and gain access to the authentication server, the usernames and passwords stored in the server may be compromised.

Biometric authentication protocols have been considered as an alternative to passwords for user identity verification. In this regard a variety of biometric authentication protocols have been developed on the basis of specific biometric features, such as fingerprints, facial recognition, speech recognition, retina/iris scanning, and hand geometry. While existing biometric authentication protocols may be useful, their effectiveness may be limited by various factors such as the ability to circumvent the technology (e.g., by presenting a static image of a face to a camera), the need for expensive custom hardware, etc. Such protocols may also require users to engage in precise and repetitive actions so that a suitably accurate measurement of biometric features may be performed, potentially degrading user experience.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a flow chart of example high level operations of one example of a process for producing a biometric template consistent with various embodiments of the present disclosure.

FIG. 2 is a flow chart of example operations of one example of a process for producing a biometric template consistent with various embodiments of the present disclosure, including example operations for producing a calibrated model of a body part.

FIG. 3 is a flow chart of example operations of one example of a process for producing a biometric template consistent with various embodiments of the present disclosure, including example operations for determining biometric features of a body part.

FIG. 4 is a flow chart of example operations of one example of a process for producing a biometric template consistent with various embodiments of the present disclosure, including example operations for producing and storing a biometric template.

FIG. 5 is a flow chart of example operations of one example of a process for performing biometric authentication consistent with various embodiments of the present disclosure.

FIG. 6 is a flow chart of example operations of another example of a process for performing biometric authentication consistent with various embodiments of the present disclosure.

FIG. 7 depicts one example of a biometric authentication system consistent with various embodiments of the present disclosure.

FIG. 8 depicts example skeletal parameters of a hand, consistent with various embodiments of the present disclosure.

FIG. 9 depicts one example of a model of a hand in which certain semantic points are identified, consistent with the present disclosure.

FIG. 10. depicts one example of a model of a hand in which the palm is identified as a region of interest, consistent with the present disclosure.

FIG. 11 is a flow chart of example operations consistent with one example of a process for comparing extracted biometric features to biometric reference information, consistent with the present disclosure

### DETAILED DESCRIPTION

The present disclosure generally relates to technologies for learning the body part geometry, and biometric authentication technologies using the same. According to one aspect, the technologies include systems, methods and computer readable media that are configured to determine one or more biometric features of a user. In some embodiments the biometric feature(s) may be determined by leveraging a calibrated computer model of a body part of the user, as well as depth information in a depth image of the body part. As will be described in detail below, the technologies can use the biometric features to generate a biometric template, e.g., in an enrollment process. Once a biometric template has been created, the technologies may use the biometric template to verify the identity of a user via biometric authentication.

Various aspects and examples of the technologies of the present disclosure will now be described. It should be understood that while the technologies of the present disclosure are described herein with reference to illustrative embodiments for particular applications, such embodiments are exemplary only and that the invention as defined by the appended claims is not limited thereto.

Indeed for the sake of illustration the present disclosure focuses on embodiments in which the technologies described herein are used to determine biometric features of a human hand, to create a biometric template including such features as biometric reference information, and to perform biometric authentication. It should be understood that such discussions are for the sake of illustration only, and that the technologies described herein may be used in other contexts and with body parts other than a hand. Those skilled in the relevant art(s) with access to the teachings provided herein will recognize additional modifications, applications, and embodiments within the scope of this disclosure, and additional fields in which embodiments of the present disclosure would be of utility.

The technologies described herein may be implemented using one or more electronic devices. The terms “device,” “devices,” “electronic device” and “electronic devices” are interchangeably used herein to refer individually or collectively to any of the large number of electronic devices that may be used as a biometric authentication system consistent with the present disclosure. Non-limiting examples of devices that may be used in accordance with the present disclosure include any kind of mobile device and/or stationary device, such as cameras, cell phones, computer terminals, desktop computers, electronic readers, facsimile machines, kiosks, netbook computers, notebook computers, internet devices, payment terminals, personal digital assistants, media players and/or recorders, security terminals, servers, set-top boxes, smart phones, tablet personal computers, ultra-mobile personal computers, wired telephones, combinations thereof, and the like. Such devices may be portable or stationary. Without limitation, in some embodiments the technologies herein are implemented in the form of a system for generating a biometric template or a system for performing biometric authentication, wherein such systems include or are in the form of one or more cellular phones, desktop computers, electronic readers, laptop computers, security terminals, set-top boxes, smart phones, tablet personal computers, televisions, or ultra-mobile personal computers.

For ease of illustration and understanding, the specification describes and the FIGS. depict various methods and systems as implemented in or with a single electronic device. It should be understood that such description and illustration is for the sake of example only and that the various elements and functions described herein may be distributed among and performed by any suitable number of devices. For example, the present disclosure envisions embodiments in which a first electronic device is configured to perform an enrollment process in which biometric features of a body part are determined and incorporated into a biometric reference template, whereas a second electronic device is configured to perform biometric authentication operations that utilize the biometric reference template generated by the first device.

The term “biometric information” is used herein to refer to observable physiological or behavioral traits of human beings (or other animals) that may be used to identify the presence of a human being (or other animal) and/or the identity of a specific human being (or other animal). Non-limiting examples of biometric information include biometric features such as biosignals (brain waves, cardiac signals, etc.), ear shape, eyes (e.g., iris, retina), deoxyribonucleic acid (DNA), face, finger/thumb prints, gait, hand geometry, handwriting, keystroke (i.e., typing patterns or characteristics), odor, skin texture, thermography, vascular patterns (e.g., finger, palm and/or eye vein patterns), skeletal parameters (e.g., joint measurements, range of movement, bone length, bone contours, etc.) and voice of a human (or other animal), combinations thereof, and the like. Such feature may be detectable using one or more sensors, such as an optical or infrared camera, iris scanner, facial recognition system, voice recognition system, finger/thumbprint device, eye scanner, biosignal scanner (e.g., electrocardiogram, electroencephalogram, etc.), DNA analyzer, gait analyzer, combinations thereof, and the like.

Without limitation, in some embodiments the technologies described herein utilize biometric features of a first body part of a human in various operations, such as the generation of a biometric template and the performance of biometric authentication. For example, in such embodiments the first body part may be a human hand, and the biometric features may include be or include features of the hand. Non-limiting examples of such features include skeletal features of the hand, tissue features of the hand, surface features of the hand, or one or more combinations thereof.

Example skeletal features of a hand include but are not limited to a circumference of a knuckle and/or a joint of said hand, a length of a knuckle and/or joint of said hand, a length of a finger bone of said hand, a length of a bone extending between two or more joints of a finger of said hand, or one or more combinations thereof.

Example tissue features of a hand include but are not limited to a skin thickness in at least one region of the hand, a blood vessel pattern of at least a portion of said hand, or a combination thereof.

Example surface features of said hand include but are not limited to a palm print of said hand, a finger print of a finger of said hand, a contour map of at least a portion of said hand, or a combination thereof.

The term “biometric reference template” is used herein to refer to a data structure containing biometric reference information of a user (e.g., biometric features of a first body part of the user), particularly when the user is the target of a biometric authentication protocol. The term “biometric reference information” is used herein to refer to biometric information (features) of a user and/or one or more body parts of a user that is/are contained in a biometric reference template.

In various instances the present disclosure describes embodiments in which biometric information of a first body part (e.g., a hand) is used, e.g., to develop a biometric template and/or to perform biometric authentication of a user. As will be described later, in some embodiments the biometric template may include “supplemental biometric reference information.” In such contexts it should be understood that the term “supplemental biometric information” is used to denote biometric information of the user that is not obtained from the first body part. For example, supplemental biometric information may include biometric information obtained from at least a second body part of a user, such as the user's face, eyes, mouth, teeth, combinations thereof, and the like. Alternatively or additionally, supplemental biometric reference information may include the gait of the user, the voice of the user, etc.

With this in mind, the term “supplemental biometric reference information” is used to refer to supplemental biometric information (e.g., features) that is included in a biometric template. In such instances it should be understood that the biometric reference information and supplemental biometric reference information may be contained in the same or different biometric reference templates.

The term “pose” is used herein to refer to the configuration of a body part. In the case of a hand, for example, the term “pose” refers to the overall arrangement of the elements of the hand, such as the fingers, thumb, palm, etc., as they may be presented to a system consistent with the present disclosure. Similarly in terms of other body parts such as a foot or a face, the term pose refers to the overall arrangement of the elements of the foot (e.g., the sole, heel, toes, arch, etc.) or the face (e.g., the eyes, nose, mouth, teeth, chin, eyebrows, etc.), as they may be presented to a system consistent with the present disclosure.

Unless otherwise stated to the contrary herein, the terms “substantially,” and “about” when used in connection with a value or a range are interchangeably used herein to refer +/−5% of the indicated amount or range. As used in any embodiment herein, the term “module” may refer to software, firmware, and circuitry configured to perform one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules may, collectively or individually, be embodied as circuitry that forms a part of one or more devices, as defined previously. In some embodiments one or more modules described herein may be in the form of logic that is implemented at least in part in hardware to perform one or more object detection and/or filtering operations described herein.

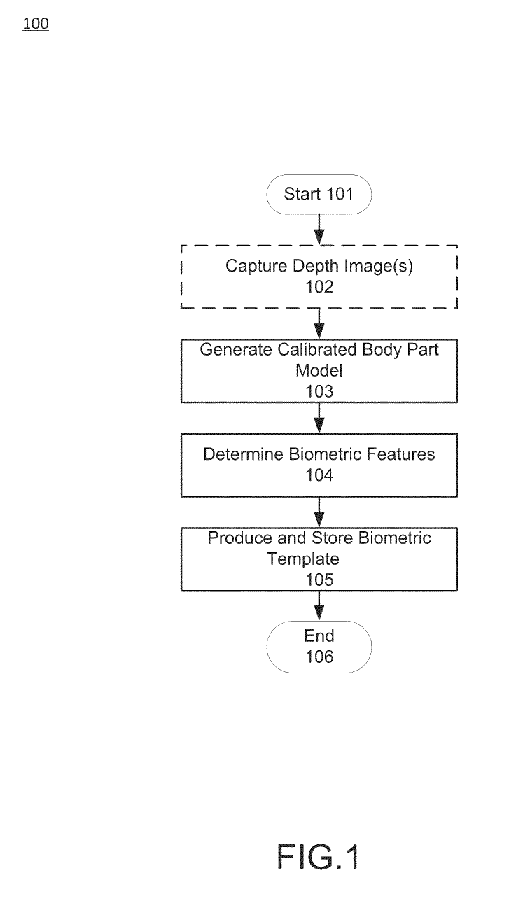

One aspect of the present disclosure relates to methods for determining biometric features of a user and, more particularly, to methods of producing a biometric reference template from biometric features of at least one body part of a user. In this regard reference is made to FIG. 1, which illustrates example high level operations of a method consistent with the present disclosure. As shown in FIG. 1, method 100 begins at block 101. The method may then proceed to optional block 101. Pursuant to this optional block, one or more depth images may be captured, e.g., by imaging the at least one body part of the user with a depth sensor.

Once one or more depth image(s) have been captured (or if depth images of a body part of the user are provided in some other manner) the method may proceed to block 103. Pursuant to this block, a calibrated computer model (“calibrated model) of the body part(s) under consideration may be developed. As will be described in detail later, generation of the calibrated model may entail comparing the depth information in the depth image(s) to one or more hypotheses produced by an un-calibrated model of the body part. The result of such comparison may be the generation of calibration parameters which may be used to fit the un-calibrated model to the body part in question. In this way, the technologies of the present disclosure may develop a calibrated model that is customized to the body part(s) under consideration. In any case, it should be understood that the calibrated model may be understood to provide an accurate representation of the body part(s) under consideration. Indeed in some embodiments the calibrated model can provide an accurate model of one or more of the skeletal features, tissue features, and surface features of the body part(s) under consideration.

Once a calibrated model of the body part(s) under consideration is generated, the method may proceed to block 104, wherein biometric features of the body part may be determined. As will be described in detail below, determining the biometric features of the body part in question in some embodiments may entail using the calibrated model to identify the location of one or more semantic points (i.e., known features) of the body part(s) within a depth image. Biometric information may then be determined based at least in part on one or more selected semantic points, e.g., from the calibrated model, the depth information in the depth image, or a combination thereof.

Once one or more biometric features of the body part(s) in question is/are determined the method may proceed to block 105, wherein one or more biometric templates may be generated. As will be described in detail later, production of a biometric template in some embodiments may entail incorporating the biometric features determined pursuant to block 104 into a data structure as biometric reference information. Although any suitable data structure may be employed, in some embodiments the data structure is in the form of a database. In some embodiments the biometric reference information in the biometric reference template may be supplemented with other information, such as supplemental biometric reference information.

Once a desired number of biometric reference templates have been produced the method may proceed to block 106 and end. As such, FIG. 1 may be understood as depicting example high level operations of an enrollment phase of a biometric authentication protocol consistent with the present disclosure.

The present disclosure will now proceed to describe features of various elements of the method of FIG. 1, as they may be implemented in accordance with various non-limiting embodiments. It should be understood that the description of such elements is for the sake of example only, and that the elements of FIG. 1 may be accomplished in any suitable manner.

Turning specifically to optional block 102 of FIG. 1, as noted above one or more depth images may be captured. In general, a depth image is all or a portion of an image that is captured by a depth sensor, such as but not limited to a depth camera. A depth camera may be understood as a camera which captures depth images—typically one frame or a sequence of frames—, often at multiple frames per second. Each depth image contains per-pixel depth information, that is, each pixel in the image has a value that represents the distance between a corresponding area of an object in an imaged scene, and the camera.

Depth cameras are sometimes referred to as three-dimensional (3D) cameras. A depth camera may contain a depth image sensor, an optical lens, and an illumination source, among other components. The depth image sensor may rely on one of several different sensor technologies. Among these sensor technologies are time-of-flight, known as “TOF”, (including scanning TOF or array TOF), structured light, laser speckle pattern technology, stereoscopic cameras, active stereoscopic sensors, depth from focus technologies, and depth from shading technologies. Most of these techniques rely on active sensors, in the sense that they supply their own illumination source. In contrast, passive sensor techniques, such as stereoscopic cameras, do not supply their own illumination source, but depend instead on ambient environmental lighting. In addition to depth information, the cameras may also generate color data, in the same way that conventional color cameras do, and the color data may be combined with the depth information for processing.

The depth information generated by depth cameras may have several advantages over data generated by conventional, two-dimensional “2D” cameras. For example, depth information can simplify the problem of segmenting the background of an image from objects in the foreground. Depth information may also be robust to changes in lighting conditions, and can be used effectively to interpret occlusions. Using one or more depth sensors such as depth cameras, it is possible to identify and track a body part of a user in real-time, such as one or both of the user's hands and/or his fingers in real-time. In this regard, the following describes methods that employ depth images to track one or more body parts.

As may be understood from the foregoing, one or more depth images may be obtained by imaging the body part(s) of a user under consideration with a depth camera. Alternatively or additionally, one or more depth image(s) may be obtained from another source. For example, one or more depth images may be obtained from a (optionally verified) database of depth images of one or more body parts of a user. In such instances optional block 102 may not be required (and thus may be omitted), and method 100 may include operations in which one or more depth images are acquired from the database, e.g., via wired and/or wireless communication.

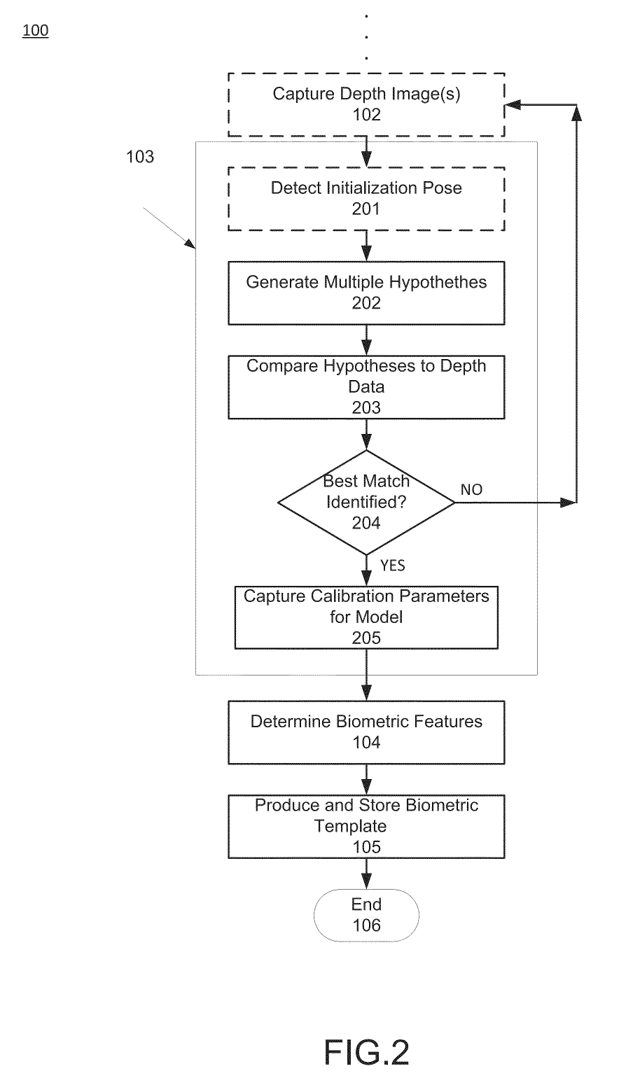

Once one or more depth images have been acquired the method may proceed to block 103, pursuant to which a calibrated model of the body part(s) in question is generated. In this regard reference is made to FIG. 2, which depicts a flow chart including more detailed example operations that may be performed pursuant to block 103 in accordance with various embodiments of the present disclosure.

Before describing the elements of FIG. 2 in detail, it is noted that the technologies of the present disclosure employ a calibrated three dimensional (3D) skeleton model of the body part in question, which may be in the form of a hand, a foot, a face, or another body part of a human or non-human animal. In some embodiments the body part in question is a hand of a human user, the 3D skeleton model is of the user's hand, and the model is calibrated to provide an accurate representation of the user's hand.

One non-limiting example of a 3D skinned hand model that may be used in accordance with the present disclosure is a skinned hand model described, which is briefly described below for the sake of ease of understanding. In general, the 3D hand skeleton model may be in the form of a hierarchical graph, where the nodes of the graph represent the skeletal joints of the hand, the edges correspond to the bones of the skeleton of the hand. Each bone in the skeleton may have a fixed length and may be connected to other bones by a joint, each of which may rotate in three or fewer dimensions. The model is thus configurable and able to accurately reproduce the movements of a human hand. Furthermore, constraints may be imposed on the rotation of the joints, e.g., to restrict movements of the model skeleton to the natural movements of the human hand. For example, in some embodiments one or more joints of the model skeleton may be constrained to one or two dimensions, e.g., so as to mimic the movement of certain joints in the human hand.

In addition to the skeleton the models used herein may also contain a mesh. In general, the mesh may be a geometrical structure of vertices and associated edges that are constrained to move based on the movements of the skeleton joints. In some embodiments the mesh may be composed of polygons. For example, a mesh corresponding to the fingers of a hand may be composed of cylinders, spheres, combinations thereof, and the like, which may be modeled from polygons. It is noted however that a cylinder-based model may provide only a rough approximation of the actual shape of a human hand and thus, in some embodiments the cylinder-based model may be relaxed to produce a 3D model geometry that more closely approximates that of a human hand.

In some embodiments the geometrical structure of the mesh may be “skinned” so that movements of the mesh vertices are controlled by associated joints. In this regard it is noted that various methods of skinning are known, and any suitable method may be used to skin the models used in accordance with the present disclosure.

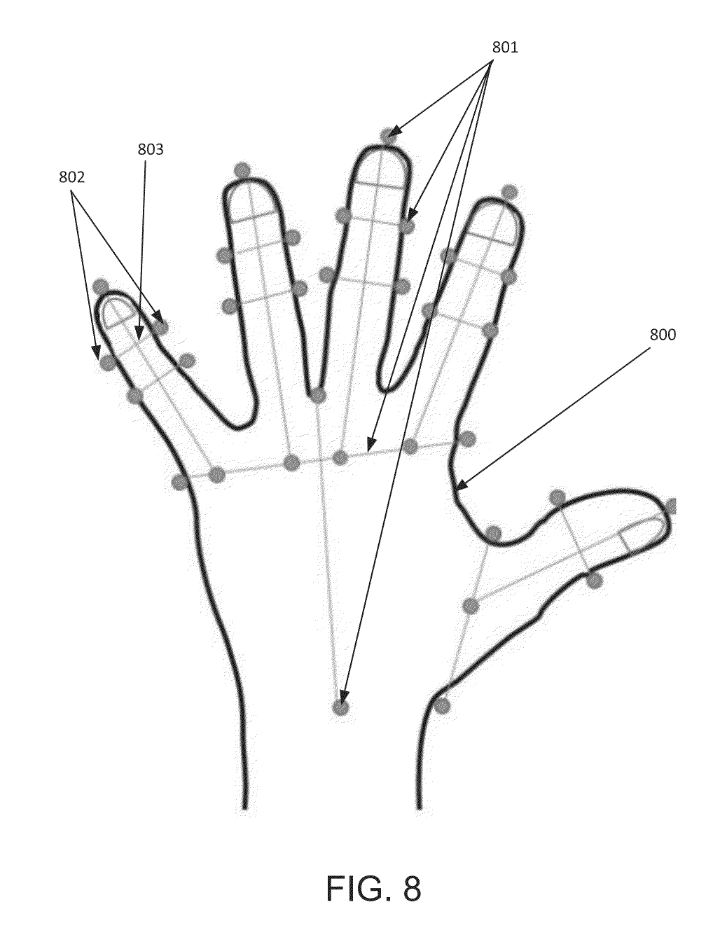

As explained above the models of the present disclosure may model the skeleton of a body part in question, such as a human hand. To illustrate this concept reference is made to FIG. 8, which illustrates an outline of a human hand 800 and various skeleton parameters 801 that may be used to describe its geometry. In the illustrated embodiment, seventeen skeleton parameters 801 are illustrated, namely the lengths of each finger, the widths at each knuckle of each finger, the width of the palm at the base joints of the four fingers (excluding the thumb), and the length of the palm from the base of the four fingers to the wrist joint. Of course, FIG. 8 merely depicts one example in which seventeen skeletal parameters are used, and it should be understood that any number of skeletal parameters may be employed.

As may be appreciated, any or all of skeletal parameters 801 may differ from person to person. Moreover, the surface features of a hand may also differ from person to person. For example, skeletal parameters such as those shown in FIG. 8 may differ widely from person to person. Other features such as the size, shape, contour, and other parameters of a body part (e.g., a hand) of one person may also differ (perhaps dramatically) from that of another person. Therefore prior to the use of a model in the production of a biometric template and/or a biometric authentication process consistent with the present disclosure, the model should be calibrated to the particular proportions of the body part(s) (e.g., hand) of a particular user.

As will be discussed in detail below, calibration of the model may involve adjusting the lengths of the model skeleton to fit the depth information in the depth image, i.e., the depth information corresponding to the body part in question (e.g., a user's hand). More specifically, during calibration there may be two objectives, namely: 1) to adjust the skeleton parameters of the model to fit the body part in question; and 2) to accurately compute the 3D positions of the joints (e.g., hand joints) of the body part.

As shown in FIG. 2, generation of a calibrated model of the body part pursuant to block 103 may begin with optional block 201. Pursuant to optional block 201, a user may be prompted to place the body part in question (e.g., a hand) in an initialization pose. In general an initialization pose may be understood to be any desired pose of a body part, such as a pose that may provide particularly accurate depth measurements. In some embodiments the initialization pose may be a pose that correlates to a default pose expected by an (un-calibrated) model of the body part in question. For example where the body part is a hand, the initialization pose may be one or more hand poses, such as, but not limited to, a closed palm pose, open palm pose, one, two, three or four finger raised pose, combinations thereof and the like. Without limitation, in some embodiments the body part is a hand and the initialization pose is an open palm pose in which the hand is presented with an open palm, fingers spread, in front of a depth sensor such as a depth camera. One or more depth images of the body part in the initialization pose may then be acquired, e.g., with a depth sensor such as a depth camera. In some embodiments, depth images of the body part in multiple orientations (e.g. both the front and back) may be acquired at this stage.

Assuming an initialization pose is used, pursuant to optional block 201 one or more gesture detection operations may be employed to determine whether the body part in question is in the initialization pose. Various gesture recognition techniques can be used to perform this task. For example in some embodiments template matching and Haar-like feature-based classifiers (and, by extension, cascade classifiers) are used to detect whether the body part is in the initialization pose. Alternatively, some implementations may detect explicit features of the hands, such as the shapes of individual fingers, and then combine multiple individual features to recognize the hand in the image. In many instances the gesture detection operations may be facilitated by combining the depth image with other image data, such as color (red, green, blue) data, infrared data, amplitude data, combinations thereof, and the like, if they are available. By way of example, depth information may be with amplitude data for gesture recognition purposes. In some embodiments, gesture recognition may be performed by generating a silhouette of the body part in question, and analyzing the contour of the silhouette to determine the pose of the body part.

While some embodiments of the present disclosure initiate the generation of a calibrated model with a determination of whether the body part in question is in an initialization pose, it should be understood that such a determination is not required. Indeed the present disclosure envisions and encompasses embodiments in which a calibrated model may be developed without the use of an initialization pose, and/or without a determination that the body part under consideration was in the initialization pose when the depth frame(s) were acquired. For example, in some embodiments no initialization pose is used, and skeleton tracking may be employed to track the body part under consideration. As the body part is tracked, depth images of the body part (e.g., produced by a depth camera) may be analyzed to determine calibration parameters (discussed below) which may be applied to calibrate the model to the body part under consideration.

When an initialization pose is detected or if detection of an initialization pose is not required the method may proceed to block 202, wherein a multiple hypothesis method may be employed to iteratively adjust the parameters of the model skeleton (e.g., on an ad hoc basis) until they sufficiently match the depth information in the depth image obtained from the depth sensor. More specifically, in some embodiments features of the body part in question (e.g., a hand) may be identified from the depth image, and the parameters of the skeleton model may be adjusted based at least in part on those identified features. Color (red, green, and blue), infrared, and/or amplitude data may also be used in conjunction with the depth images to detect features of the body part in question. In any case, the pose of the body part, including articulation of the skeleton joints may be computed as part of calibrating the model.

More specifically pursuant to block 202, a multiple hypothesis method may be employed to calibrate the model. In the multiple hypothesis methods of the present disclosure, the parameters of an (un-calibrated) model of the body part (e.g., hand) in question may be adjusted on an ad hoc basis to produce a plurality of hypotheses for the skeleton parameters of the model, such as skeleton parameters 801 of FIG. 8. The model may then be rendered using each set of hypothetical skeleton parameters, so as to produce a hypothetical depth map corresponding to each set of hypothetical depth parameters.

Once one or more hypotheses have been developed (or after a plurality of hypotheses have been developed) the method may proceed to block 203, wherein each hypothesis is tested against the depth information from the depth image under consideration. In some embodiments, each hypothesis (e.g., each depth map) may be evaluated to determine the degree to which it is similar to the depth information from the depth image. Although any suitable method may be used to perform this comparison, in some embodiments the comparison is performed using an objective function and/or a motion model.

In any case, the method may proceed to block 204, wherein a determination may be made as to whether one or more of the hypotheses substantially matches the depth information in the depth image. If not, the method may loop back to optional block 102, wherein additional depth images may be acquired, optionally from the body part in an initialization pose. In any case if a hypothesis substantially matching the depth information of the depth image is not found, the method may develop additional hypotheses pursuant to block 202 for comparison to the depth information in one or more depth image(s). If a hypothesis that sufficiently matches the depth information is found, however, the hypothesis that most closely matches the depth information may be considered a “best” hypothesis and the method may proceed to block 205. Pursuant to that block calibration parameters that may be applied to calibrate the model to the body part in question may be determined based at least in part on the best hypothesis. The calibration parameters for the model may then be stored, e.g., in a database and optionally in association with a user profile associated with a user. In this context the term, “calibration parameters” refers to the skeletal parameter values that were used to generate the best hypothesis.

As may be appreciated by the foregoing, the models described herein may be calibrated such that they provide an accurate 3D representation of one of more features of a body part of interest. For example in the case of a hand, calibration parameters may be applied to fit the model to a hand of a user, such that the model accurately represents the skeleton of the user's hand, either alone or in combination with one or more of tissue features of the user's hand and surface features of the user's hand. Furthermore once calibrated, the model may be used to accurately track the motion of the user's hand through various configurations.

Once a calibrated model has been obtained the method may proceed from block 103 of FIG. 1 to block 104, wherein one or more biometric features of the body part in question may be determined. As will be described in detail below, the determination of the biometric feature(s) may be accomplished based at least in part on the calibrated model.

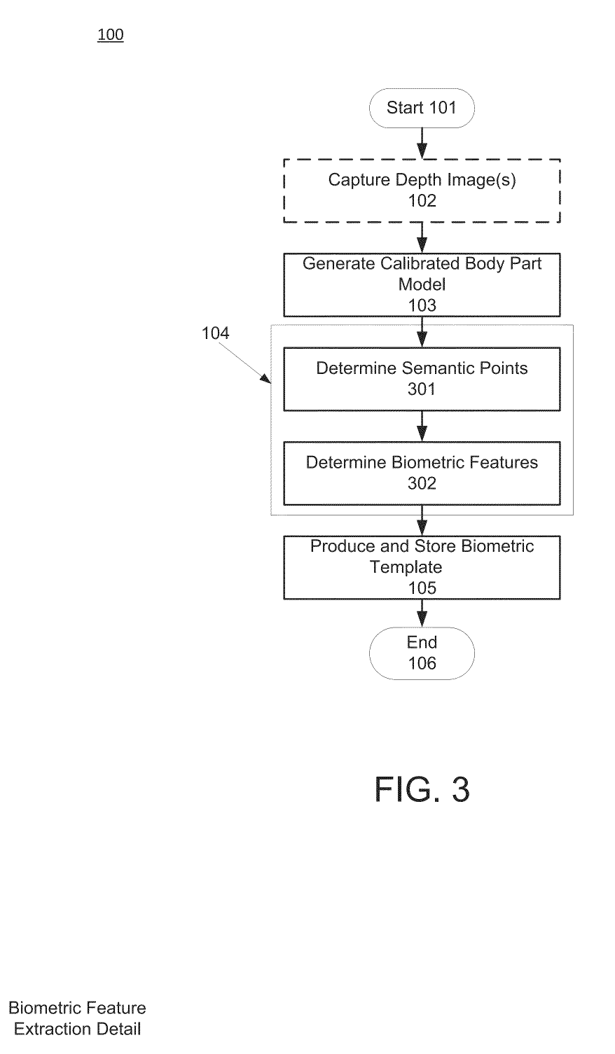

In this regard reference is made to FIG. 3, which depicts more detailed example operations that may be performed pursuant to block 104 of FIG. 1. As shown in FIG. 3, the determination of one or more biometric features of a body part in question may begin with block 301, wherein one or more semantic points may be identified. In general, a semantic point may be understood as a point of a depth image that corresponds to a known feature of the body part under consideration. For example in instances where the body part is a hand, semantic points may correspond to points in a depth image that correspond to one or more knuckles of the hand, one or more surface wrinkles (e.g., palm lines), one or more fingertips, the base of the palm, one or more edges of the hand, combinations thereof, and the like. In some embodiments, the body part in question is a hand and the semantic points include or are in the form of specific features of the fingers of the hand, such as the fingertips.

Semantic points may be identified in any suitable manner. For example in some embodiments semantic points may be computed from a depth image using image processing techniques, which may be any technique that is capable of identifying a region of a body part from an image. These operations may be performed with and/or facilitated by the use of color and/or infrared images.

In some implementations the body part in question is a hand, and semantic points may be identified by detecting edges corresponding to the center axes of the fingers. In such instances those edges may be used to approximate individual fingers by roughly fitting a piecewise continuous line composed of up to three segments, where the three segments correspond to the three bones of a finger. Alternatively or additionally, local maxima may be detected in the depth image or a hand blob (i.e., a portion of the depth image that corresponds to the body part of interest, and which has been segmented from the background) thereof and used as semantic points indicating the positions of the fingertips. Local maxima are regions of the depth image where surrounding pixels have values further away from the camera than the center of the region. Local maxima correspond to features indicating, for example, fingertips pointing towards the camera, since the pixels at the periphery of the fingers are generally further away from the camera, and thus may have uniformly higher depth values.

Alternatively or additionally, semantic points may be determined at least in part using the calibrated hand model. For example, various parameters of the hand model such as the skeletal parameters described above may be associated with known features of a human hand, such as the knuckles, fingertips, base of the palm, etc. Because the location of such features is known in the model and the model is calibrated as discussed above, the location of semantic features corresponding to specific points in the model may be mapped to the depth information. Conversely, semantic points may be determined by image processing the depth image as discussed above, after which such points may be mapped to the calibrated model.

More specifically, one or more of the calibration parameters used to produce the calibrated model may be used to generate a mathematical function describing the relationship of one or more semantic points identified in the model to the depth information in the depth image obtained from the body part in question. Thus for example, one or more knuckles, a portion of the palm, the fingertips, etc. of a hand may be identified in the calibrated model as semantic points, and may be mapped by the calibrated model to specific pixels or groups of pixels in the depth image. Alternative or additionally, semantic points may be identified by image processing the depth image, after which the identified points may be mapped to corresponding points of the calibrated model.

In some embodiments, once a semantic point has been identified and associated with a specific portion of the body part in question, it may be labeled accordingly. For example, semantic points identified as fingertips may be labeled as corresponding to a specific fingertip, e.g., the fingertip of the index finger, of the thumb, etc. In some embodiments, machine learning algorithms are used to label semantic points as specific points of a body part in question, such as specific parts of a hand. Once one or more semantic points have been identified the method may proceed to block 302 of FIG. 3, wherein one or more biometric features of the body part in question may be determined. Such determination may be performed in any suitable manner, such as through an analysis of the calibrated model, an analysis of the depth image, or a combination thereof.

Without limitation, in some embodiments one or more biometric features may be determined at least in part by analyzing one or more portions of the calibrated model. More specifically, one or more biometric features of the body part may be determined by selecting one or more semantic points of the body part in question, which as noted above may be accurately reproduced and identified in the calibrated model. Once one or more of the semantic points has been identified, one or more biometric features may be calculated, measured, or otherwise determined using the selected semantic point(s) as a point of reference.

By way of example, in instances where the body part under consideration is a hand, semantic points corresponding to each side of the distal knuckle of the pinky may be identified as selected semantic points. This concept is illustrated in FIG. 8, in which points 802 are the selected semantic points and correspond to the relevant skeletal parameters of the pinky. In such embodiments, the calibrated model may calculate, measure, or otherwise determine biometric features using points 802 as a reference. For example, using the calibrated model the linear distance between points 802 (i.e., distance 803) may be determined. Alternatively or additionally, the circumference of the joint may also be calculated, measured, or otherwise determined.

In other non-limiting embodiments, one or more biometric features may be determined at least in part by an analysis of the depth information in the depth image of the body part under consideration. As in the prior example in which the body part is a hand, one or more semantic points may be determined, e.g., by image processing the depth image and/or by mapping one or more semantic features identified in the calibrated model to the depth information of the depth image. In either case, the semantic points may be used as reference points from which one or more biometric features may be determined. For example, image processing techniques may be applied to calculate, measure, or otherwise determine the linear distance (e.g., width) 803 between points 802, e.g. in instances wherein points 802 are selected semantic points. Also like the previous example, a circumference of the distal knuckle of the pinky may be determined, in which one or more of points 802 is/are a selected semantic point.

While the foregoing examples focus on embodiments in which points 802 are selected semantic points and the biometric features determined include one or both of a linear distance of a knuckle (width) and a circumference of a knuckle, it should be understood that those examples are for the sake of illustration only. Other semantic points may be used as selected semantic points, from which any number and/or type of biometric features may be determined from the calibrated model, the depth image, or a combination thereof. Indeed the present disclosure envisions embodiments in which the features include one or more skeletal features of a body part, tissue features of a body part, surface features of a body part, or one or more combinations thereof.

In some embodiments the body part in question is a hand, and the biometric features include one or more features of the hand, such as but not limited to skeletal features of the hand, tissue features of the hand, surface features of the hand, or one or more combinations thereof. In some embodiments the features are skeletal features of the hand, and include or are selected from one or more of a circumference of a knuckle of a joint of the hand, a length and/or width of a joint of the hand, a length of a finger bone of the hand, a length of a bone extending between two or more joints of a finger of the hand, a width of the palm of the hand, combinations thereof, and the like.

Alternatively or in addition to the above noted skeletal features, in some embodiments the body part in question is a hand, and the biometric features include one or more tissue features of the hand. Non-limiting examples of tissue features that may be used include the skin thickness of the hand in at least one region thereof, an average skin thickness of the entire hand, a blood vessel pattern of at least a portion of the hand, or combinations thereof.

In still further embodiments, alternatively or in addition to one or more of the above noted skeletal and tissue features, in some embodiments the body part in question is a hand, and the biometric features include one or more surface features of the hand. Non-limiting examples of surface features that may be used include a palm print of the hand, a contour map of at least a portion of the hand, or combinations thereof.

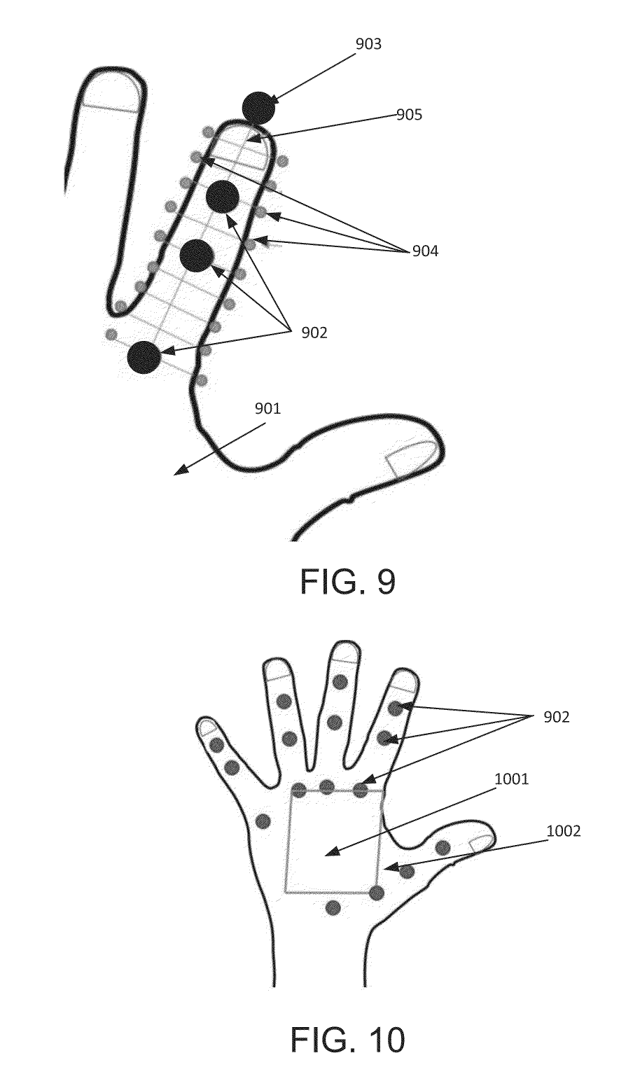

To further illustrate the foregoing concepts, in some embodiments the body part in question may be a hand, and semantic points correlating to specific points on the hand geometry may be identified pursuant to block 301 of FIG. 3. Without limitation, in some embodiments the points of the hand identified as semantic points may include the tip of each finger, the base of each finger, one or more knuckles of each finger, the location of the wrist, and combinations thereof. This concept is illustrated in FIG. 9, which illustrates one example of a hand 901 in which joints 902 and tip 903 of an index finger (not labeled) are identified as semantic points.

Pursuant to block 302 of FIG. 3, one or more biometric features of hand 901 may be extracted from first and second depth images thereof, wherein the first depth image is of the front of hand 901, and the second depth image is of the back of hand 901. In this regard, a calibrated model of hand 901 may be used to identify the position of knuckles 902 and tip 903 as semantic points 902, and to correlate those positions to corresponding portions of the depth data in the first and second depth images. Once semantic points 902 have been identified in the depth data of the first and second depth images of hand 901, the regions between two knuckles 902 and between one of the knuckles 902 and tip 903 may be further subdivided, for example, by taking the points midway between the semantic points. In some embodiments, each band may be bounded by endpoints 904 of the border of the finger, such that a line extending from between the endpoints of each band may bisect the median 905 of the finger, e.g., as generally shown in FIG. 9. It is noted the number of bands illustrated in FIG. 9 is relatively small for the sake of illustration and clarity. It should be understood that such illustration is for the sake of example only, and that any suitable number of bands may be employed.

Regardless of the number of depth bands, the identified depth bands in the first and second depth images may be associated with an index, with corresponding depth bands in each image being identified with the same index. In this regard, two depth bands may be considered corresponding if they are located at the same position relative to common semantic points.

With the foregoing in mind the depth data along each depth band may be sampled and used to calculate the circumference of the finger(s). The resulting set of calculated circumferences may then provide an accurate description of the geometry of the user's body part, and in some embodiments may be sufficient to use as a biometric feature that is sufficient to identify a user, either alone or in combination with other biometric information. Alternatively, the calculated circumferences for each finger may be plotted against their indices and the curvature of that plot may be determined and used as a biometric feature of the user.

Alternatively or additionally, depth data along each depth band may be sampled and used to calculate the 3D world position of each point on the surface of the hand. As above, the resulting set of calculated 3D world positions may be associated with an index, which in turn may be associated with a particular depth band. In any case, the set of 3D world positions may provide a highly detailed description of the hand geometry of a user. As such, all or a portion of the set of 3d world positions may be sufficient to use as biometric feature of the user, either alone or in combination with other biometric information.

The foregoing discussion focused on embodiments in which two depth images of a hand are used, as may be suitable for example in a use case in which a user is prompted to present the front and back of a hand to a depth camera. It should be understood that such description is for the sake of example, and that in some embodiments biometric features of the body part in question may be extracted from a plurality of depth images, and in some cases regardless of orientation and/or rotation of the body part.

For example, skeleton tracking may be used to track the motion of a hand of the user and depth images of the hand may be acquired, e.g., periodically or at random intervals. As the depth images are acquired, the skeleton tracking may also update the calibrated model of the hand. Simultaneously or subsequently, the calibrated model may be used to identify semantic points of the hand, and to map those semantic points to the acquired depth images. Because the calibrated model provides an accurate 3D model of the hand, the same semantic points of the hand may be identified in the model regardless of hand position or orientation. Provided those semantic points are visible to the depth camera acquiring the depth images, the model maps the identified semantic points to the depth data acquired of the users hand. In other words, the determination of the position of semantic points within depth images of the body part may be rotation and/or orientation invariant, provided the semantic point is visible to the depth camera. As will be described below, this may allow biometric features of the body part of interest to be extracted in an asynchronous manner.

Specifically, in some embodiments semantic features of the body part (e.g., hand) may be identified in a first depth image of the body part, as discussed above. Using those semantic features, the regions between the depth data may be subdivided into bands, and each band may be assigned an index, as discussed above. The data along those bands may then be sampled. As the hand moves and is tracked, another (e.g., second) depth image of the hand may be acquired. The calibrated model may identify the same semantic points of the hand in the second depth image, after which the regions between the semantic points may be subdivided into bands and sampled. As in the first image, each band may be assigned an index. As a result, each band of depth data in the second (or subsequent) image(s) is matched to bands of depth data obtained in the first (or other) depth images.

This process may continue as the hand is moved, until a desired amount of depth images have been sampled. At that point, the depth data associated with each index may be used to compute or otherwise determine biometric features of the hand. In the hand use case, for example, the depth data acquired from the depth images and which is associated with a particular index may in some embodiments be used to calculate a circumference of a finger at that index. Similarly, 3D world coordinates of each point of a hand and along a particular index may be determined from the depth data acquired from the depth images of the hand that is associated with that same index. In this manner, biometric features such as finger circumference, 3D world position of the surface of various points of the hand, etc. may be determined over a period of time.

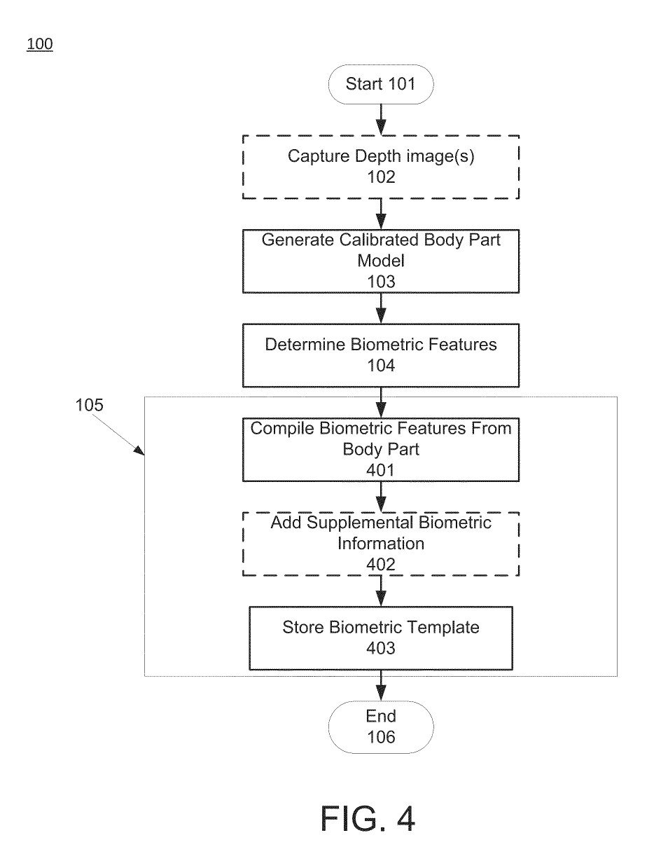

Returning to FIGS. 1-4, once one or more biometric features of the body part in question are determined, the method may proceed to block 105, wherein a biometric template may be produced. In this regard specific reference is made to FIG. 4, which depicts more detailed example operations that may be performed in accordance with the objectives of block 105. As shown in FIG. 4, in some embodiments production of a biometric template may begin by compiling the biometric features determined pursuant to block 104. Compiling of the biometric features in some embodiments may include aggregating various biometric features determined pursuant to block 104 into one or more data structures. In this regard any suitable data storage structure may be used, although in preferred embodiments the data storage structure is or includes a database (or, more particularly, a database storage structure that may be included in a database). In any case, the biometric features determined pursuant to block 104 may be included in the data structure as biometric reference information. As will be described later the data structure (or, more particularly, the biometric reference information contained therein) may later be employed as a biometric reference template in a biometric authentication process.

Before or after the production of a data structure the method may proceed to optional block 402. Pursuant to this optional block the biometric features determined pursuant to block 104 may be supplemented with additional biometric information, hereinafter called “supplemental biometric information.” In general, supplemental biometric information may be understood as biometric information of a user that is other than the biometric features determined pursuant to block 104. For example where the body part under consideration is a first body part of a user (e.g., a hand), supplemental biometric information may be in the form of one or more other biometric features of the user. Non-limiting examples of such other biometric features include a voice of the user, a gait of the user, biometric features obtained from one or more (e.g., second) body parts of the user other than the first body part (e.g., the face of the user, a foot of the user, an ear of the user, an eye of the user, etc.), other features (e.g., a palm print) of the same body part (e.g., hand) used to produce the biometric reference information (e.g., finger circumference, 3D world position, etc.).

Without limitation, in some embodiments the supplemental biometric information is in the form of a palm print of a hand of a user. In this regard it is noted that the palm print of a hand of a user may be extracted from depth images in much the same manner as described above with respect to FIG. 9 and the determination of 3D world coordinates of points of one or more fingers. With reference to FIG. 10, the calibrated model may be used to identify semantic points 902 of hand 901, as previously described. In these embodiments however, semantic points 902 may include the joint at the base of the thumb as well as one or more joints corresponding to the base of the fingers. Using these joints, a region of interest (in this case, the palm) may be determined by the model, e.g., by drawing a quadrilateral (e.g. a parallelogram) bounded by a first line bisecting the joints at the base of the index, middle and ring fingers, a second line extending parallel to the first line and bisecting the joint at the base of the thumb, and third and fourth lines connecting the first and second lines. This concept is illustrated in the embodiment of FIG. 10, in which box 1001 depicts the region of interest. Once the region of interest has been identified, the region may be subdivided into bands, and depth data along those bands may be sampled as discussed above. The sampled depth data at each band may then be used to determine various features, such as the 3D world coordinates of the surface of each point (including the surface of the palm) within a band, the thickness of the hand within each band, etc. Such information may constitute supplemental biometric information that may facilitate or enhance the identification of a user. As such, it may be incorporated into a biometric template as supplemental biometric information, e.g., in much the same manner as described above.

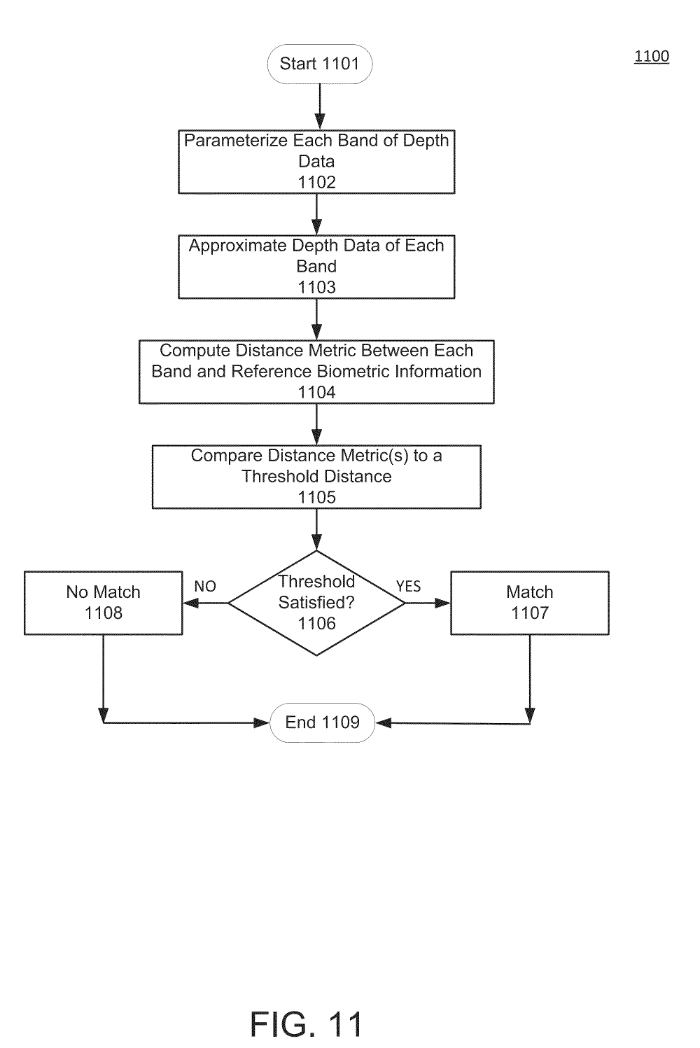

Alternatively or additionally, in some embodiments the bands of depth data acquired from the body part may be utilized as a biometric template. That is, alternatively or in addition to determining the above noted features of the body part, the bands of depth data (optionally indexed) may be considered biometric information of the user, and may themselves be stored in a biometric template. In some embodiments, the depth data in these bands may be used to determine one or more reference feature vectors (e.g., in a similar manner as described later in connection with FIG. 11) that may be compared to feature vectors determined from depth data acquired from a user in connection with a biometric authentication process.

In instances where supplemental biometric information is used, it may be compiled in the same or a different data structure as the biometric features determined pursuant to block 104 (e.g., from a first body part). Like the biometric features determined pursuant to block 104, the supplemental biometric information may be compiled (e.g., as supplemental biometric reference information) in any suitable data structure, such as but not limited to a database. As will be described later the data structure (or, more particularly, the biometric reference information and supplemental biometric reference information contained therein) may later be employed as a biometric reference template in a biometric authentication process.

Once the biometric features determined pursuant to block 104 and optionally the supplemental biometric information have been compiled into one or more data structures, the method may proceed to block 403, pursuant to which the data structures may be stored as biometric templates for later use, e.g., in a biometric authentication process. Storage of the data structures may be performed in any suitable manner, such as by including the data structures into one or more databases, which may be stored on a biometric authentication system or a remote computer system. Once the data structured have been stored the method may proceed to block 106 and end.

The foregoing discussion has focused on methods in which one or more biometric features of a body part may be determined from a depth image and used to produce a biometric template. With this in mind, another aspect of the present disclosure relates to methods for performing biometric authentication. As will become apparent from the following discussion, use of the technologies described herein can in some embodiments facilitate the performance of both active biometric authentication and passive biometric authentication. As used herein, the term “active biometric authentication” refers to a biometric authentication process in which a user presents a body part in a specific pose for biometric authentication. In contrast, the term “passive biometric authentication” reference to a biometric authentication process in which a user is not required to present a body part in a specific pose for biometric authentication, e.g., where authentication may be performed while the user is engaged in another activity.

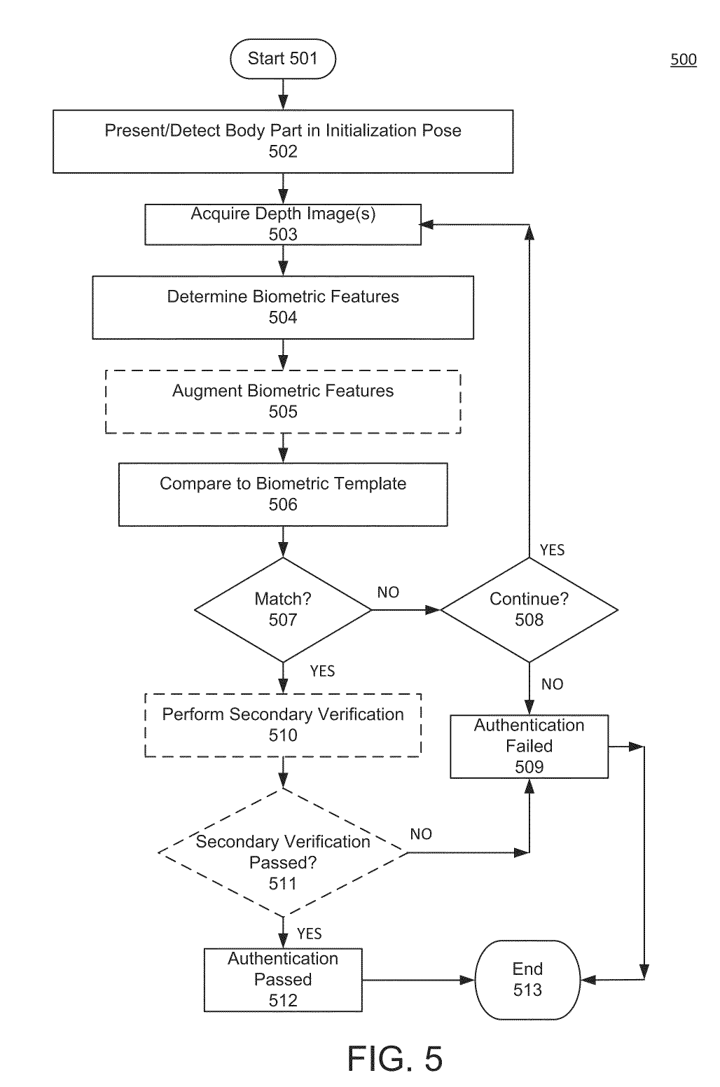

Reference is therefore made to FIG. 5, which depicts example operations of an active biometric authentication process consistent with the present disclosure. As shown, method 500 begins with block 501. The method may then proceed to block 502, wherein a user is prompted to present a body part in an initialization pose. Alternatively, a user may present a body part in an initialization pose without being prompted to do so. In either case, operations pursuant to block 502 may include detecting the initialization pose. The nature of the initialization poses that may be used and the manner by which such poses may be detected are substantially the same as described above with respect to optional block 201 of FIG. 2. A detailed explanation of initialization poses and the manner by which an initialization pose may be detected is therefore not reiterated for the sake of brevity. Without limitation, in some embodiments the body part is a hand, and the initialization pose is an open palm pose (e.g., open palm, five fingers raised and spread). Detection of the initialization pose in some embodiments is performed at least in part by performing one or more gesture recognition operations, e.g., on one or more images acquired by a camera, a depth sensor, or some other suitable device.

Once the initialization pose has been detected the method may proceed to block 503, wherein one or more depth images of the body part may be acquired with a depth sensor such as a depth camera. Like the depth images discussed previously in connection with FIGS. 1-4, the depth images acquired pursuant to block 503 include depth information of the body part.

Once one or more depth images have been acquired from the body part in the initialization pose, the method may proceed to block 504, during which one or more biometric features may be determined. For the sake of clarity, such biometric features are referred to as “extracted biometric features”. In some embodiments, the extracted biometric features may be determined in much the same manner as described above with regard to FIGS. 2-4, 9 and 10. That is, in some embodiments a multiple hypothesis method may be employed to generate a calibrated model of the body part. One or more semantic points may be determined from the calibrated model and/or the depth image. The semantic points may then be used as reference points from which one or more extracted biometric features may be calculated, measured, or otherwise determined.

In an alternative embodiment, prior to the initiation of method 500 a user may optionally provide some other identification indicia to assert his identity. By way of example, a user may provide a biometric sample (e.g., voice, retina, fingerprint, etc.), a username and password, etc., which may be used to assert his identity to a biometric authentication system. Based on the provided identification indicia, the biometric authentication system may identify a user profile associated with the user, e.g., via a lookup operation. The user profile may associate the user with one or more biometric templates, as well as calibration parameters that may be used to generate a calibrated model of a body part (e.g., a hand) of the user. Method 500 may then proceed as described above with regard to blocks 502-504, except that the calibration parameters associated with the user profile may be used to generate a calibrated model of the body part in question. As may be appreciated, such embodiments avoid the need to re-determine calibration factors that are used to calibrate the model of the body part to the specific user. Like the previously described embodiments, semantic points may then be determined and used to calculate, measure, or otherwise determine extracted biometric features of the body part in question.

As will be described later, the biometric authentication methods described herein compare extracted biometric features of a body part under consideration to biometric reference information in one or more biometric reference templates. For the comparison to be meaningful, the extracted biometric features in some embodiments should include at least the same type of biometric features as the biometric reference information stored in one or more biometric reference template. With the foregoing in mind, in some embodiments the biometric features determined pursuant to block 504 may include one or more skeletal features, tissue features, surface features, or combinations thereof. Non-limiting examples of such features include the same biometric features discussed above in connection with block 104 of FIGS. 1-4. Such example features are therefore not reiterated for the sake of brevity. In some embodiments, the biometric features determined pursuant to block 504 include one or more skeletal features of the user's hand, the circumference of one of more fingers of the user's hand, a combination thereof, or the like.

Once one or more extracted biometric features have been determined the method may proceed to optional block 505, wherein the extracted biometric feature(s) may be augmented with additional information. The additional information in some embodiments may include additional biometric features of the user. As noted above, the biometric authentication methods compare extracted biometric features obtained from one or more depth image(s) of a body part to biometric reference information in a biometric template. In some embodiments, however, the biometric features determined from one depth image may be insufficient to determine whether there is a match between the extracted biometric features and the biometric reference information. With this in mind, in some embodiments the extracted biometric features may be augmented with additional biometric features determined from one or more additional depth images of the body part under consideration.

This concept is illustrated in blocks 506-508 of FIG. 5. Pursuant to block 506, extracted biometric features are compared to biometric reference information in one or more biometric templates. In instances where a user has provided other identification indicia to identify a user profile, the comparison may focus on evaluating the similarity of the extracted biometric features to biometric reference information in a biometric reference template associated with the user profile. Otherwise the comparison may evaluate the similarity of the extracted biometric features to biometric reference information of a plurality of biometric reference templates in an effort to determine a match.

At block 507, a determination is made as to whether the extracted biometric features and biometric reference information in a biometric reference template match, either identically or greater than or equal to a threshold degree of similarity. If the extracted features and biometric reference information in a biometric reference template do not match, the method may proceed to block 508.

Pursuant to block 508, a determination may be made as to whether the method is to continue. The outcome of block 508 may depend on one or more factors, such as a time limit, whether the lack of a match was due to insufficient extracted biometric features (e.g., when the extracted biometric features determined pursuant to block 504 do not include one or more biometric features of the biometric reference information), whether the comparison performed pursuant to block 506 was able to eliminate one or more biometric reference templates from consideration or not, combinations thereof, or the like. In any case if the method is to continue, the method may loop back to block 503, wherein one or more additional depth image(s) may be acquired. Pursuant to blocks 504 and 505, the method may attempt to detect additional biometric features of the body part, and to augment the previously extracted biometric features with newly extracted biometric features. A comparison between the augmented extracted biometric features and the biometric reference information may then be performed pursuant to block 506. The loop of blocks 503-508 may continue until a match is detected, or until it is determined that the method is not to continue, in which case the method may proceed from block 508 to block 509, whereupon biometric authentication fails. The method may then proceed to block 513 and end.

FIG. 11 is a flow chart of one example of a method of comparing extracted biometric features to biometric reference information consistent with the present disclosure. For the sake of this method, it is assumed that a user has presented a hand for biometric verification of his identity. It is also assumed that depth data acquired from the user's hand has been segmented into indexed depth bands as generally discussed above, and in instances where the depth data was acquired from multiple depth images of the hand (in the same or different orientations), that corresponding depth bands in the various image(s) are correlated with one another by a common index. Finally, this method assumes that the biometric reference information has been parameterized and used to develop one or more feature vectors (e.g., in the same or similar as described below with regard to the parameterization of depth data measured in accordance with a biometric authentication operation), and that a plurality of biometric template containing biometric reference information are stored in a database. It should be understood however that the concepts and operations described in connection with this method may be employed to compare other types of biometric information and other types of biometric reference information.

As shown in FIG. 11, method 1100 begins at block 1101. The method may then proceed to block 1102, wherein the depth data within each depth band is parameterized. In some embodiments parameterization of the depth data is performed on successive (e.g., sequential) pixels, so that each band may be represented by the function f(t), tε[0,T], wherein t is a variable indicating at which point the function f is sampled.

The method may then proceed to block 1103, wherein the values of the depth bands are approximated with one or more basis functions, such that:

$$f ( t ) \sim {\sum }_{i}^{N} {a}_{i} {b}_{i} ( t )$$

in which (bᵢ)(t) are the basis functions, N is the number of basis functions used in the approximation of a band, and may be any suitable number, i is the index of the basis function, and aᵢ is an approximation coefficient(s). In some embodiments, a polynomial basis function is used, such that bᵢ(t)=tⁱ. Alternatively, a spline basis function or another basis function may be used. In any case, the approximation may be determined for each depth band.

Once the value of each depth band has been approximated the method may proceed to block 1104, wherein, for each depth band, feature vectors are constructed from the approximation coefficient(s) ai, and a distance metric representing the difference between two feature vectors is used to compare the depth data captured from the user's hand with the biometric reference information in a database of biometric reference templates. Without limitation, in some embodiments this is performed by concatenating all of the approximation coefficients ai for each band and determining a single feature vector from the concatenation of the approximation coefficients. Specifically, feature vectors may be constructed for each depth band based on their respective approximation coefficients and subsequently, a cumulative distance metric derived from all of the respective depth bands can be computed, given the distance metrics of all of the individual depth bands.

In any case the method may proceed to blocks 1105 and 1106 wherein the distance metric(s) calculated pursuant to block 1104 may be compared to a threshold (hereinafter called a threshold distance), and a determination is made as to whether the threshold is satisfied (with regard to the entirety of the measured depth data or an individual band). In this context, the threshold distance may be understood to represent a maximum distance by which the depth data/feature vector(s) of the measured depth data may differ from the depth data/feature vector(s) of biometric reference information in a database in order to constitute a match. If the distance between a depth band/feature vector of the measured depth data and corresponding depth data/feature vector of biometric reference information in the database is less than or equal to the threshold, the method may proceed to block 1107, wherein a match may be indicated. Alternatively if the distance between a depth band/feature vector of the measured depth data and corresponding depth data/feature vector of biometric reference information in the database is higher than the threshold, the method may proceed to block 1108, wherein it is determined that there is no match.

In instances where individual bands of measured depth data and/or feature vectors thereof are being compared to individual bands of depth data and/or feature vectors of biometric reference information, the determination pursuant to block 1106 in some embodiments may be conditioned on the comparison returning a threshold number of “match” or “no match” results. Thus for example, the comparison and determination made pursuant to block 1105 and 1106 may proceed on a depth band/feature vector by depth band/feature vector basis, with each comparison resulting in a match or no match determination. The comparison may iterate for each depth band/feature vector, until all of the measured depth bands/feature vectors have been compared to corresponding depth bands/feature vectors of the biometric reference information in the database of biometric templates.

The total number of match and no match results may then be compared to one or more thresholds, so as to determine whether the measured depth data overall matches one biometric reference information in the database. For example, when the total number of measured depth band/feature vectors matching corresponding bands of biometric reference information meets or exceeds a threshold number, a determination may be made that the measured depth data matches that biometric reference information. Conversely when the total number of measured depth band/feature vectors matching corresponding bands of biometric reference information is less than a threshold number (or, alternatively, the total number of measured depth band/feature vectors that do not match corresponding depth bands/vectors of biometric information meets or exceeds a threshold number), a determination may be made that the measured depth data matches that biometric reference information. In any case, after the match or no match determination is made method 1100 may proceed from blocks 1108 or 1107 to block 1109 and end.

Returning to FIG. 5, if it is determined pursuant to block 507 that there is a match between extracted biometric features and biometric reference information the method may proceed to optional block 510, wherein a secondary verification process may be executed. In general, a secondary verification process may be understood as a process that may be used to further verify the presence of the user. That is, it may protect against attempts to bypass the biometric authentication system, e.g., by presenting a static image of the body part, a 3d model of the body part, combinations thereof, and the like. In some embodiments the secondary verification process may require the user to perform a specific action with the body part in question. For example, pursuant to the secondary verification process a user may be prompted to move the body part in question in a particular manner, such as in a circle, a swipe, between two or more gestures, combinations thereof, and the like. In some embodiments the body part in question is a hand, and the secondary verification process prompts a user to perform an action with the hand, e.g., to make a particular motion with the hand (e.g., a circular or square motion), to present one or more gestures with the hand (e.g., open palm, closed palm, fist, etc.), combinations thereof, and the like.

After prompting the user to perform an action with the body part, the secondary process may further involve monitoring for the performance of the action. Any suitable technique may be applied in this regard. For example, gesture recognition techniques may be applied to detect specific gestures, skeleton tracking (as discussed above) may be applied to analyze the motion of the body part, etc. Without limitation, in some embodiments the secondary process involves prompting a user to move the body part under consideration in a specific manner, and using skeleton tracking to monitor the motion of the body part as the user performs the requested action.

In some embodiments the secondary verification process may be based on supplemental biometric information of the user. In such instances the supplemental biometric information may in some embodiments be the same as the supplemental biometric information discussed above in regard to FIG. 4. A detailed description of supplemental biometric information is therefore not reiterated here. Regardless of the nature of the supplemental biometric information, when it is used the secondary verification process may entail obtaining a measured sampled of the secondary biometric information (“measured supplemental biometric information) using an appropriate sensor, such as a camera, palm sensor, finger print scanner, retinal scanner, etc.

In instances where a secondary verification process is applied pursuant to block 510, the method may proceed to block 511, wherein a determination may be made as to whether the secondary verification has passed or failed. In instances where the secondary verification relies on the performance of a requested action, the outcome of this determination may depend on the analysis of the body part that was performed pursuant to block 510 as the user performs the requested action. Specifically, the outcome may depend on a determination of whether the requested action was performed by the user correctly, i.e., in a manner that is identical or sufficiently similar to the requested action. If not, the method may proceed from block 511 to block 509, wherein authentication fails. The method may then proceed to block 513 and end.

Alternatively where secondary authentication relies on supplemental biometric information, the outcome of the determination in some embodiments depends on a comparison of the measured supplementary biometric information to supplementary biometric reference information contained in one or biometric reference templates. In this regard, the supplementary biometric reference information may be included in the same biometric template as the biometric reference information corresponding to the body part under consideration, or a different biometric template. In the latter case, the biometric reference template containing the supplementary biometric reference information may be correlated or otherwise associated with the biometric template containing the biometric reference information of the body part under consideration. Regardless, the outcome of block 511 may turn on a comparison of the measured supplemental biometric information to the supplemental biometric reference information. If the measured supplemental biometric information does not substantially match the supplemental biometric reference information, the method may proceed from block 511 to block 509, wherein authentication fails. The method may then proceed to block 513 and end.

In either case if secondary verification passes or if secondary verification is not required, the method may proceed to block 512, wherein authentication passes. The method may then proceed from block 512 to block 513 and end.

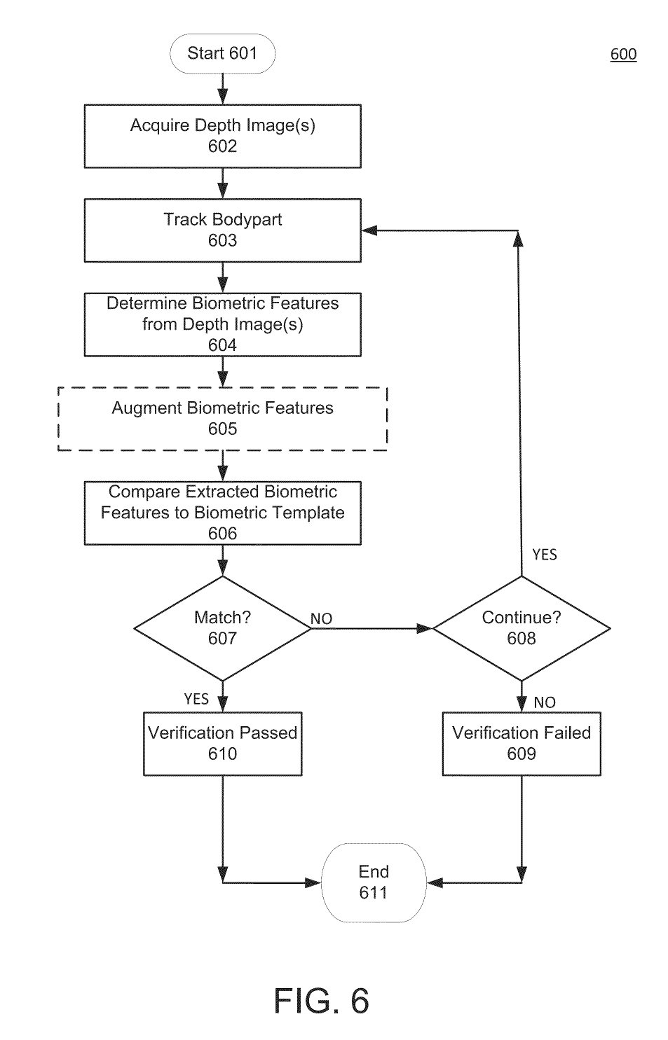

Reference is now made to FIG. 6, which is a flow chart of example operations of a method of performing adaptive biometric authentication consistent with the present disclosure. As will become apparent, this method may allow biometric authentication to be performed without requiring a user to perform a specific action to initiate the process. For example and unlike method 500 of FIG. 5, method 600 may allow a user to by biometrically authenticated without the need to present a body part in an initialization pose.

With the foregoing in mind, as shown in FIG. 6 method 600 begins at block 601. The method may then proceed to block 602, wherein one or more depth mages of a body part of the user may be acquired, e.g., with a depth sensor such as a depth camera. The nature and content of the depth images has been previously described, and therefore is not reiterated for the sake of brevity. The method may then proceed to block 603, wherein the body part under consideration may be tracked, e.g., with a skeleton tracking technique. Examples of suitable skeleton tracking techniques include but are not limited to those described above. In general, the skeleton tracking techniques may function to track the body part as it is moved by the user, during which time additional depth images of the body part may optionally be acquired. The method may then proceed to block 604, wherein biometric features may be determined from the depth image(s). As may be appreciated, tracking of the body part (e.g., using skeleton tracking or another technique) may avoid the user having to present the body part in a predetermined pose. As a result, the user can move naturally and the biometric information from his body part(s) may be extracted implicitly.

In general the determination of biometric features pursuant to block 604 may proceed in much the same manner as described above with respect to block 504 of FIG. 5. For example, in some embodiments a multiple hypothesis method may be employed to determine calibration parameters from the depth image(s) and to calibrate a model of the body part to the user. Alternatively, the user may present other identification indicia to assert his identity to the biometric authentication system, and which may be used to identify a user profile containing calibration parameters previously determined for the user. In any case, once the calibration parameters have been identified, a calibrated model of the body part may be generated, semantic points may be identified, and one or more biometric features (“extracted biometric features”) may be calculated, measured, or otherwise determined based on one or more of the semantic points.

As noted above, depth images of the body part in question may be captured as the user is engaged in various activities, and/or as the user moves the body part around. Depending on the orientation of the body part to a depth sensor, it may not be possible to determine some biometric features from one particular depth image of the body part. For example, certain positions of the body part may occlude one or more features of the body part from the depth sensor, which may hinder or prevent determining certain biometric features from that depth image. Thus while an analysis of one depth image may allow for the determination of some extracted biometric features, those features may not be sufficient alone to verify the identity of the user.

With this in mind, method 600 may address this issue in some embodiments by augmenting extracted biometric features from one depth image with biometric features extracted from additional depth images. This concept is illustrated in FIG. 6 by optional block 605, which indicates that extracted biometric features determined to block 604 may be augmented with additional biometric features, e.g., which may be determined by the loop defined by blocks 603-608. In this regard it is noted that the operations of blocks 603-608 are substantially similar to those described above in connection with blocks 503-508 of FIG. 5, except insofar as the additional depth image(s) are acquired by imaging the body part in question as the user is engaged in various activities, as opposed to presenting the body part in an initialization pose.

As biometric features are extracted and optionally augmented, the method pursuant to block 606 may compare the extracted biometric features to biometric reference information in one or more biometric reference template. As discussed above, the comparison may focus on the degree to which the extracted features are similar to the biometric reference information. Pursuant to block 607, a determination is made as to whether the extracted biometric features match or substantially match biometric reference information (or, more specifically, biometric features) in a biometric reference template. If not the method may proceed to block 608, wherein a determination is made as to whether the method is to continue. The outcome of block 608 may depend on one or more of the same considerations as the outcome of block 508 of FIG. 5. If the method is to continue, it may loop back to blocks 603-605, wherein the body part may be tracked, additional depth image(s) of the body part may be acquired, and additional biometric features may be determined.

This loop may continue until a match is detected in block 607 or it is determined that the method should not continue pursuant to block 608. If pursuant to block 608 it is determined that the method should not continue, the method may proceed to block 609 wherein verification fails. The method may then proceed from block 609 to block 611 and end.

If a match is detected pursuant to block 607, however, the method may proceed to block 610, wherein verification passes and the method may proceed to block 611 and end.

Although not shown in FIG. 6, in some embodiments a supplemental verification process may be applied subsequent to the detection of a match pursuant to block 607, and prior to an indication that verification has passed. For example, a verification process that is similar or identical to that described in connection with optional blocks 510 and 511 of FIG. 5 may be used. When secondary verification is used, an indication that authentication of the user has passed may be conditioned on the successful performance of the secondary verification process, as described above.

Another aspect of the present disclosure relates to systems for performing biometric authentication operations consistent with the present disclosure. Non-limiting examples of biometric authentication operations that may be performed by the systems include biometric template generation operations and biometric authentication operations. Examples of biometric template generation operations include but are not limited to the operations described above in connection with FIGS. 1-4. Example of biometric authentication operations include but are not limited to the operations described above in connection with FIGS. 5, 6 and 11.

For the sake of clarity and ease of understanding the present disclosure will proceed to describe embodiments in which a single system is configured to perform both biometric template generation and biometric authentication operations consistent with the present disclosure. While such embodiments may be particularly useful in some implementations, it should be understood that those embodiments are for the sake of example only and that the performance of biometric template generation operations and biometric authentication operations may be performed by separate systems. Such systems may be referred to herein as a system for generating a biometric template, a system for performing biometric authentication, or, collectively, a biometric authentication system. In any case, it should be understood that the biometric template generation operations and biometric authentication operations may be performed by one system or multiple different systems, regardless of the particular notation used herein. Therefore a system for generating a biometric template may also be configured to perform biometric authentication operations, and a system for performing biometric authentication may also be configured to perform biometric template generation operations.

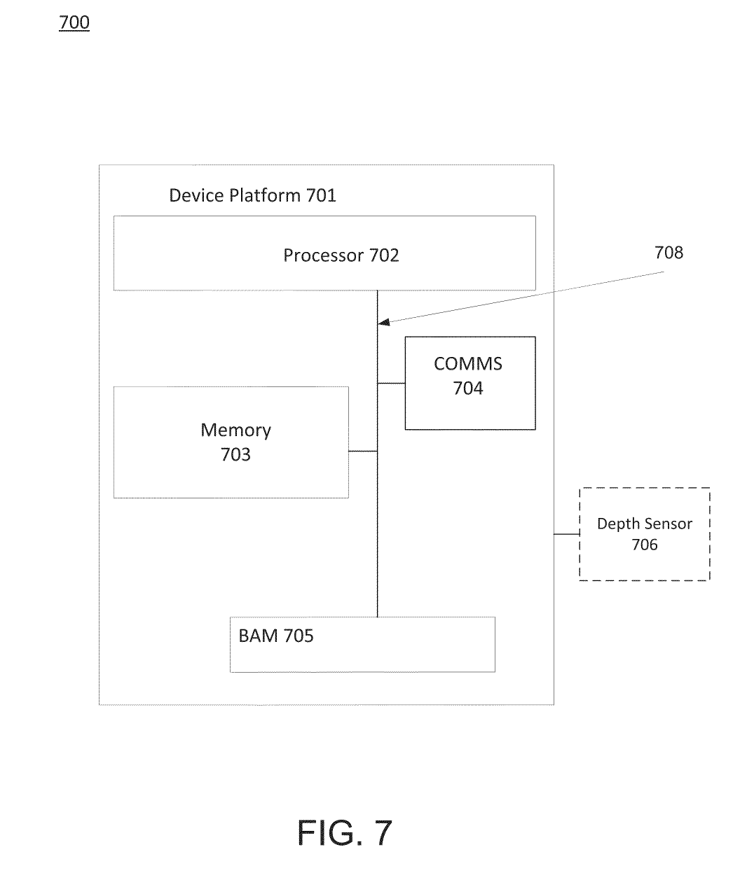

With the foregoing in mind reference is made to FIG. 7, which is a block diagram of one example of a biometric authentication system consistent with the present disclosure. System 700 may be in the form of an electronic device such as those described above. Without limitation, in some embodiments system 700 is in the form of a cellular phone, desktop computer, electronic reader, laptop computer, security terminal, set-top box, smart phone, tablet personal computer, television, or ultra-mobile personal computer.

As shown, system 700 includes device platform 701, which may be any suitable device platform. In some embodiments device platform correlates to the type of electronic device used as system 700. Thus for example where system 700 is in the form of a cellular phone, a smart phone, a security terminal, or a desktop computer, device platform 701 may be a cellular phone platform, a smart phone platform, a security terminal platform, or a desktop computer platform, respectively.

Device platform 701 includes processor 702, memory 703, communications interface (COMMS) 704, biometric authentication module (BAM) 705, and optional depth sensor 706. Such components may communicate with one another via interconnect 708, which is an abstraction that represents any one or more separate physical buses, point to point connections, or both connected by appropriate bridges, adapters, or controllers. In some embodiments interconnect 708 may include or be in the form of one or more of a system bus, a Peripheral Component Interconnect (PCI) bus, a Hyper Transport or industry standard architecture (ISA) bus, a small computer system interface (SCSI) bus, a universal serial bus (USB), IIC (I2C) bus, or an Institute of Electrical and Electronics Engineers (IEEE) standard 694 bus, sometimes referred to as “Fire wire”.

Processor(s) 702 can include central processing units (CPUs) and graphical processing units (GPUs) that can execute software or firmware stored in memory 703. The processor(s) 702 may be, or may include, one or more programmable general-purpose or special-purpose microprocessors, digital signal processors (DSPs), programmable, application specific integrated circuits (ASICs), programmable logic devices (PLDs), or the like, or a combination of such devices.

Memory 703 represents any form of memory, such as random access memory (RAM), read-only memory (ROM), flash memory, or a combination of such devices. In use, in some embodiments memory 703 can contain, among other things, a set of computer readable instructions which, when executed by processor 702, causes system 700 to perform operations to implement biometric template generation operations and/or biometric authentication operations consistent with the present disclosure.

COMMS 704 is generally configured to enable communication between system 700 and one or more computing platforms, devices, sensors, etc., e.g., using a predetermined wired or wireless communications protocol, such as but not limited to an Internet Protocol, WI-FI protocol, BLUETOOTH protocol, combinations thereof, and the like. COMMS 704 may therefore include hardware (i.e., circuitry), software, or a combination of hardware and software that allows system 700 to send and receive data signals to/from one or more computing systems, sensors, servers, etc., with which it may be in communication. COMMS 704 may therefore include one or more transponders, antennas, BLUETOOTH® chips, personal area network chips, near field communication chips, Wi-Fi chips, cellular antennas, combinations thereof, and the like.

As noted above, system 700 may also include depth sensor 706. Depth sensor 706 may be any suitable type of depth sensor, such as but not limited to a depth camera. In some embodiments depth sensor may be external to device platform 701, e.g., as a standalone sensor or a sensor that may be in communication with device platform 701, e.g., via COMMS 704. This concept is illustrated in FIG. 7, which depicts an embodiment in which depth sensor 706 is external to device platform 701. Of course that illustration is for the sake of example only, and it should be understood that other configurations may be used. For example, in some embodiments depth sensor 706 may be integral with device platform 701, in which case it too may be coupled to processor 702, memory 703, etc., via interconnect 708.

In some embodiments and as illustrated in FIG. 7, device platform 701 may include a biometric authentication module (BAM) 705. For the sake of illustration, BAM 705 is illustrated as a separate component of device platform 701, as in some embodiments it may be present as logic implemented at least in part on hardware to perform various biometric template operations and/or biometric authentication operations consistent with the present disclosure. Of course this illustration is an example only, and it should be understood that BAM 705 may be provided on device platform 701 in some other fashion. For example, BAM 705 may be in the form of or include computer readable instructions that are stored on device platform 201 (e.g., in memory 203), and which when executed by processor 702 cause system 700 to perform biometric template generation and/or biometric authentication operations consistent with the present disclosure. As such operations have been described above in connection with FIGS. 1-6, reiteration of such operations in the context of execution or performance by BAM 705 is not reiterated for the sake of brevity.

System 701 may also include one or more optional input devices and/or optional display devices (both not shown). When sued, the input devices can include a keyboard and/or a mouse, and the display devices can include a cathode ray tube (CRT), liquid crystal display (LCD), or some other applicable known or convenient display device.

### EXAMPLES

The following examples pertain to further embodiments. The following examples of the present disclosure may comprise subject material such as a system, a device, a method, a computer readable storage medium storing instructions that when executed cause a machine to perform acts based on the method, and/or means for performing acts based on the method, as provided below.

### Example 1

According to this example there is provided a method for generating a biometric template, including: generating a calibrated model of a first body part of a user at least in part from depth information included in a depth image of the first body part acquired with a depth sensor; extracting one or more biometric features of the first body part at least in part using the calibrated model; and producing a biometric reference template including the biometric features of the first body part as biometric reference information.

### Example 2

This example includes any or all of the features of example 1, wherein the depth sensor includes a depth camera.

### Example 3

This example includes any or all of the features of examples 1 or 2,

wherein generating the calibrated model includes: formulating multiple hypotheses for a model of the first body part in a first position, each of the multiple hypotheses including a depth map of the first body part in the first position, wherein the first position corresponds to the position of the first body part when the depth frame is acquired; and identifying a best hypothesis from the multiple hypotheses at least in part by comparing the depth map of each of the multiple hypotheses to the depth information in the depth frame, the best hypothesis including one of the multiple hypotheses that most closely fits the depth information.

### Example 4

This example includes any or all of the features of example 3, wherein generating the calibrated model further includes: determining calibration parameters for the model of the first body part model based at least in part on the best hypothesis; and adjusting the model of the first body part using the calibration parameters to produce the calibrated model, the calibrated model accurately modeling at least the skeletal geometry of the first body part.

### Example 5

This example includes any or all of the features of any one of examples 1 and 2, wherein the extracting includes: identifying a plurality of semantic points of the first body part using the calibrated model, wherein each of the semantic points correspond to a known feature of the first body part; identifying at least one selected semantic point from the plurality of semantic points; and determining the one or more biometric features of the first body part based at least in part on the at least one selected semantic point.

### Example 6

This example includes any or all of the features of example 5, wherein the determining includes measuring at least one biometric feature of the first body part from the depth information, the calibrated model, or a combination thereof based at least in part on the at least one selected semantic point.

### Example 7

This example includes any or all of the features of example 6, wherein the determining includes measuring at least one biometric feature of the first body part based at least in part on the depth information and the at least one selected semantic point.

### Example 8

This example includes any or all of the features of example 6, wherein the determining includes measuring at least one biometric feature of the first body part from the calibrated model and the at least one selected semantic point.

### Example 9

This example includes any or all of the features of example 5, wherein the first body part is a hand, and the one or more biometric features of the first body part comprise features of the hand.

### Example 10

This example includes any or all of the features of example 9, wherein the features of the hand comprise at least one of skeletal features of the hand, tissue features of the hand, surface features of the hand, or one or more combinations thereof.

### Example 11

This example includes any or all of the features of example 9, wherein the features of the hand include skeletal features of the hand, the skeletal features including one or more of a circumference of a knuckle of a joint of the hand, a length of a joint of the hand, a length of a finger bone of the hand, a length of a bone extending between two or more joints of a finger of the hand, or one or more combinations thereof.

### Example 12

This example includes any or all of the features of example 9, wherein the features of the hand comprise tissue features of the hand, and the tissue features comprise at least one of a skin thickness in at least one region of the hand, a blood vessel pattern of at least a portion of the hand, or a combination thereof.

### Example 13

This example includes any or all of the features of example 9, wherein the features of the hand comprise surface features of the hand, and the surface features comprise a palm print of the hand, a contour map of at least a portion of the hand, or a combination thereof.

### Example 14

This example includes any or all of the features of any one of examples 1 and 2, wherein producing the biometric template includes incorporating the one or more biometric features of the first body part into a data structure.

### Example 15

This example includes any or all of the features of example 14, wherein the data structure is in the form of a database.

### Example 16

This example includes any or all of the features of any one of examples 1 and 2, further including supplementing the one or more biometric features of the first body part with supplemental biometric information.

### Example 17

This example includes any or all of the features of example 16, wherein the supplemental biometric information includes at least one biometric feature of a second body part of the user.

### Example 18

According to this example there is provided a method of performing biometric authentication, including: generating a calibrated model of a first body part at least in part from depth information included in a depth image of the first body part acquired from a user with a depth sensor; extracting one or more biometric features of the first body part at least in part using the calibrated model to produce extracted biometric features; and comparing the extracted biometric features to biometric reference information in a biometric template; denying authentication of the user's identity when the extracted biometric features and the biometric reference information do not substantially match; and verifying the user's identity when the extracted biometric features and the biometric reference information substantially match.

### Example 19

This example includes any or all of the features of example 18, wherein the depth sensor includes a depth camera.

### Example 20

This example includes any or all of the features of any one of examples 18 and 19, wherein generating the calibrated model includes: formulating multiple hypotheses for a model of the first body part in a first position, each of the multiple hypotheses including a depth map of the first body part in the first position, wherein the first position corresponds to the position of the first body part when the depth frame is acquired; and identifying a best hypothesis from the multiple hypotheses at least in part by comparing the depth map of each of the multiple hypotheses to the depth information in the depth frame, the best hypothesis including one of the multiple hypotheses that most closely fits the depth information.

### Example 21

This example includes any or all of the features of example 20, wherein generating the calibrated model further includes: determining calibration parameters for the model of the first body part based at least in part on the best hypothesis; and adjusting the model of the first body part using the calibration parameters to produce the calibrated model, the calibrated model accurately modeling at least the skeletal geometry of the first body part.

### Example 22

This example includes any or all of the features of any one of examples 18 and 19, wherein the extracting includes: identifying a plurality of semantic points of the first body part using the calibrated model, wherein each of the semantic points correspond to a known feature of the first body part; identifying at least one selected semantic point from the plurality of semantic points; and determining the one or more biometric features of the first body part based at least in part on the at least one selected semantic point.

### Example 23

This example includes any or all of the features of example 22, wherein the determining includes measuring at least one biometric feature of the first body part from the depth information, the calibrated model, or a combination thereof based at least in part on the at least one selected semantic point.

### Example 24

This example includes any or all of the features of example 23, wherein the determining includes measuring at least one biometric feature of the first body part based at least in part on the depth information and the at least one selected semantic point.

### Example 25

This example includes any or all of the features of example 23, wherein the determining includes measuring at least one biometric feature of the first body part from the calibrated model and the at least one selected semantic point.

### Example 26

This example includes any or all of the features of example 22, wherein the first body part is a hand, and the one or more biometric features of the first body part comprise features of the hand.

### Example 27

This example includes any or all of the features of example 26, wherein the features of the hand comprise at least one of skeletal features of the hand, tissue features of the hand, surface features of the hand, or one or more combinations thereof.

### Example 28

This example includes any or all of the features of example 26, wherein the features of the hand include skeletal features of the hand, the skeletal features including one or more of a circumference of a knuckle of a joint of the hand, a length of a joint of the hand, a length of a finger bone of the hand, a length of a bone extending between two or more joints of a finger of the hand, or one or more combinations thereof.

### Example 29

This example includes any or all of the features of example 26, wherein the features of the hand comprise tissue features of the hand, and the tissue features comprise at least one of a skin thickness in at least one region of the hand, a blood vessel pattern of at least a portion of the hand, or a combination thereof.

### Example 30

This example includes any or all of the features of example 26, wherein the features of the hand comprise surface features of the hand, and the surface features comprise a palm print of the hand, a contour map of at least a portion of the hand, or a combination thereof.

### Example 31

This example includes any or all of the features of any one of examples 18 and 19, wherein the biometric template is in the form of a data structure including the biometric reference information.

### Example 32

This example includes any or all of the features of example 31, wherein the data structure is in the form of a database.

### Example 33

This example includes any or all of the features of any one of examples 18 and 19, further including: comparing measured supplemental biometric information obtained from the user to supplemental biometric reference information; and denying authentication of the user's identity when at least one of the extracted biometric features or the measured supplemental biometric information does not substantially match the biometric reference information or the supplemental reference biometric information, respectively; and
verifying the user's identity when the extracted biometric features and the measured supplemental biometric information substantially match the biometric reference information and the supplemental reference biometric information, respectively.

### Example 34

This example includes any or all of the features of any one of examples 18 and 19, wherein the supplemental reference biometric information includes at least one previously obtained biometric feature of a second body part of the user, and the measured supplemental biometric information includes at least a measurement of the biometric feature of the second body part.

### Example 35

According to this example there is provided a system for generating a biometric template, including logic implemented at least in hardware to cause the system to perform the following operations including: generating a calibrated model of a first body part at least in part from depth information included in a depth image of the first body part acquired from a user with a depth sensor; extracting one or more biometric features of the first body part at least in part using the calibrated model; and producing a biometric reference template including the biometric features of the first body part as biometric reference information.

### Example 36

This example includes any or all of the features of example 35, wherein the depth sensor includes a depth camera.

### Example 37

This example includes any or all of the features of any one of examples 35 and 36, wherein generating the calibrated model includes: formulating multiple hypotheses for a model of the first body part in a first position, each of the multiple hypotheses including a depth map of the first body part in the first position, wherein the first position corresponds to the position of the first body part when the depth frame is acquired; and identifying a best hypothesis from the multiple hypotheses at least in part by comparing the depth map of each of the multiple hypotheses to the depth information in the depth frame, the best hypothesis including one of the multiple hypotheses that most closely fits the depth information.

### Example 38

This example includes any or all of the features of example 37, wherein generating the calibrated model further includes: determining calibration parameters for the model of the first body part model based at least in part on the best hypothesis; and adjusting the model of the first body part using the calibration parameters to produce the calibrated model, the calibrated model accurately modeling at least the skeletal geometry of the first body part.

### Example 39

This example includes any or all of the features of any one of examples 35 and 36, wherein the extracting includes: identifying a plurality of semantic points of the first body part using the calibrated model, wherein each of the semantic points correspond to a known feature of the first body part; identifying at least one selected semantic point from the plurality of semantic points; and determining the one or more biometric features of the first body part based at least in part on the at least one selected semantic point.

### Example 40

This example includes any or all of the features of example 39, wherein the determining includes measuring at least one biometric feature of the first body part from the depth information, the calibrated model, or a combination thereof based at least in part on the at least one selected semantic point.

### Example 41

This example includes any or all of the features of example 40, wherein the determining includes measuring at least one biometric feature of the first body part based at least in part on the depth information and the at least one selected semantic point.

### Example 42

This example includes any or all of the features of example 40, wherein the determining includes measuring at least one biometric feature of the first body part from the calibrated model and the at least one selected semantic point.

### Example 43

This example includes any or all of the features of example 40, wherein the first body part is a hand, and the one or more biometric features of the first body part comprise features of the hand.

### Example 44

This example includes any or all of the features of example 43, wherein the features of the hand comprise at least one of skeletal features of the hand, tissue features of the hand, surface features of the hand, or one or more combinations thereof.

### Example 45

This example includes any or all of the features of example 43, wherein the features of the hand include skeletal features of the hand, the skeletal features including one or more of a circumference of a knuckle of a joint of the hand, a length of a joint of the hand, a length of a finger bone of the hand, a length of a bone extending between two or more joints of a finger of the hand, or one or more combinations thereof.

### Example 46

This example includes any or all of the features of example 43, wherein the features of the hand comprise tissue features of the hand, and the tissue features comprise at least one of a skin thickness in at least one region of the hand, a blood vessel pattern of at least a portion of the hand, or a combination thereof.

### Example 47

This example includes any or all of the features of example 43, wherein the features of the hand comprise surface features of the hand, and the surface features comprise a palm print of the hand, a contour map of at least a portion of the hand, or a combination thereof.

### Example 48

This example includes any or all of the features of any one of examples 35 and 36, wherein producing the biometric template includes incorporating the one or more biometric features of the first body part into a data structure.

### Example 49

This example includes any or all of the features of example 48, wherein the data structure is in the form of a database.

### Example 50

This example includes any or all of the features of any one of examples 35 and 36, wherein the logic is further configured to cause the system to perform the following operations including: supplementing the one or more biometric features of the first body part with supplemental biometric information.

### Example 51

This example includes any or all of the features of example 50, wherein the supplemental biometric information includes at least one biometric feature of a second body part of the user.

### Example 52

According to this example there is provided a system for performing biometric authentication, including logic implemented at least in part in hardware to cause the system to perform the following operations including: generating a calibrated model of a first body part at least in part from depth information included in a depth image of the first body part acquired from a user with a depth sensor; extracting one or more biometric features of the first body part at least in part using the calibrated model to produce extracted biometric features; and comparing the extracted biometric features to a biometric template, the biometric template including biometric reference information; denying authentication of the user's identity when the extracted biometric features and the biometric reference information do not substantially match; and verifying the user's identity when the extracted biometric features and the biometric reference information substantially match.

### Example 53

This example includes any or all of the features of example 52, wherein the depth sensor includes a depth camera.

### Example 54

This example includes any or all of the features of any one of examples 52 and 53, wherein generating the calibrated model includes: formulating multiple hypotheses for a model of the first body part in a first position, each of the multiple hypotheses including a depth map of the first body part in the first position, wherein the first position corresponds to the position of the first body part when the depth frame is acquired; and identifying a best hypothesis from the multiple hypotheses at least in part by comparing the depth map of each of the multiple hypotheses to the depth information in the depth frame, the best hypothesis including one of the multiple hypotheses that most closely fits the depth information.

### Example 55

This example includes any or all of the features of example 54, wherein generating the calibrated model further includes: determining calibration parameters for the model of the first body part based at least in part on the best hypothesis; and adjusting the model of the first body part using the calibration parameters to produce the calibrated model, the calibrated model accurately modeling at least the skeletal geometry of the first body part.

### Example 56

This example includes any or all of the features of any one of examples 52 and 53, wherein the extracting includes: identifying a plurality of semantic points of the first body part using the calibrated model, wherein each of the semantic points correspond to a known feature of the first body part; identifying at least one selected semantic point from the plurality of semantic points; and determining the one or more biometric features of the first body part based at least in part on the at least one selected semantic point.

### Example 57

This example includes any or all of the features of example 56, wherein the determining includes measuring at least one biometric feature of the first body part from the depth information, the calibrated model, or a combination thereof based at least in part on the at least one selected semantic point.

### Example 58

This example includes any or all of the features of example 57, wherein the determining includes measuring at least one biometric feature of the first body part based at least in part on the depth information and the at least one selected semantic point.

### Example 59

This example includes any or all of the features of example 57, wherein the determining includes measuring at least one biometric feature of the first body part from the calibrated model and the at least one selected semantic point.

### Example 60

This example includes any or all of the features of example 56, wherein the first body part is a hand, and the one or more biometric features of the first body part comprise features of the hand.

### Example 61

This example includes any or all of the features of example 60, wherein the features of the hand comprise at least one of skeletal features of the hand, tissue features of the hand, surface features of the hand, or one or more combinations thereof.

### Example 62

This example includes any or all of the features of example 60, wherein the features of the hand include skeletal features of the hand, the skeletal features including one or more of a circumference of a knuckle of a joint of the hand, a length of a joint of the hand, a length of a finger bone of the hand, a length of a bone extending between two or more joints of a finger of the hand, or one or more combinations thereof.

### Example 63

This example includes any or all of the features of example 60, wherein the features of the hand comprise tissue features of the hand, and the tissue features comprise at least one of a skin thickness in at least one region of the hand, a blood vessel pattern of at least a portion of the hand, or a combination thereof.

### Example 64

This example includes any or all of the features of example 60, wherein the features of the hand comprise surface features of the hand, and the surface features comprise a palm print of the hand, a contour map of at least a portion of the hand, or a combination thereof.

### Example 65

This example includes any or all of the features of any one of examples 52 and 53, wherein the biometric template is in the form of a data structure including the biometric reference information.

### Example 66

This example includes any or all of the features of example 65, wherein the data structure is in the form of a database.

### Example 67

This example includes any or all of the features of any one of examples 52 and 53, further including: comparing measured supplemental biometric information obtained from the user to supplemental biometric reference information previously obtained from the user; and denying authentication of the user's identity when at least one of the extracted biometric features or the measured supplemental biometric information does not substantially match the biometric reference information or the supplemental biometric reference information, respectively; and verifying the user's identity when the extracted biometric features and the measured supplemental biometric information substantially match the biometric reference information and the supplemental biometric reference information, respectively.

### Example 68

This example includes any or all of the features of example 67, wherein the supplemental biometric reference information includes biometric information of at least a second body part of the user, and the measured supplemental biometric information includes at least a measurement of the biometric feature of the second body part.

### Example 69

According to this example there is provided at least one computer readable medium including instructions for generating a biometric template, wherein the instructions when executed by a processor of a system for generating a biometric template cause the system to perform the following operations including: generating a calibrated model of a first body part at least in part from depth information included in a depth image of the first body part acquired from a user with a depth sensor; extracting one or more biometric features of the first body part at least in part using the calibrated model; and producing a biometric reference template including the biometric features of the first body part as biometric reference information.

### Example 70

This example includes any or all of the features of example 69, wherein the depth sensor includes a depth camera.

### Example 71

This example includes any or all of the features of any one of examples 69 and 70, wherein generating the calibrated model includes: formulating multiple hypotheses for a model of the first body part in a first position, each of the multiple hypotheses including a depth map of the first body part in the first position, wherein the first position corresponds to the position of the first body part when the depth frame is acquired; and identifying a best hypothesis from the multiple hypotheses at least in part by comparing the depth map of each of the multiple hypotheses to the depth information in the depth frame, the best hypothesis including one of the multiple hypotheses that most closely fits the depth information.

### Example 72

This example includes any or all of the features of example 71, wherein generating the calibrated model further includes: determining calibration parameters for the model of the first body part model based at least in part on the best hypothesis; and adjusting the model of the first body part using the calibration parameters to produce the calibrated model, the calibrated model accurately modeling at least the skeletal geometry of the first body part.

### Example 73

This example includes any or all of the features of any one of examples 69 and 70, wherein the extracting includes: identifying a plurality of semantic points of the first body part using the calibrated model, wherein each of the semantic points correspond to a known feature of the first body part; identifying at least one selected semantic point from the plurality of semantic points; and determining the one or more biometric features of the first body part based at least in part on the at least one selected semantic point.

### Example 74

This example includes any or all of the features of example 73, wherein the determining includes measuring at least one biometric feature of the first body part from the depth information, the calibrated model, or a combination thereof based at least in part on the at least one selected semantic point.

### Example 75

This example includes any or all of the features of example 74, wherein the determining includes measuring at least one biometric feature of the first body part based at least in part on the depth information and the at least one selected semantic point.

### Example 76

This example includes any or all of the features of example 74, wherein the determining includes measuring at least one biometric feature of the first body part from the calibrated model and the at least one selected semantic point.

### Example 77

This example includes any or all of the features of example 74, wherein the first body part is a hand, and the one or more biometric features of the first body part comprise features of the hand.

### Example 78

This example includes any or all of the features of example 77, wherein the features of the hand comprise at least one of skeletal features of the hand, tissue features of the hand, surface features of the hand, or one or more combinations thereof.

### Example 79

This example includes any or all of the features of example 77, wherein the features of the hand include skeletal features of the hand, the skeletal features including one or more of a circumference of a knuckle of a joint of the hand, a length of a joint of the hand, a length of a finger bone of the hand, a length of a bone extending between two or more joints of a finger of the hand, or one or more combinations thereof.

### Example 80

This example includes any or all of the features of example 77, wherein the features of the hand comprise tissue features of the hand, and the tissue features comprise at least one of a skin thickness in at least one region of the hand, a blood vessel pattern of at least a portion of the hand, or a combination thereof.

### Example 81

This example includes any or all of the features of example 77, wherein the features of the hand comprise surface features of the hand, and the surface features comprise a palm print of the hand, a contour map of at least a portion of the hand, or a combination thereof.

### Example 82

This example includes any or all of the features of any one of examples 69 and 70, wherein producing the biometric template includes incorporating the one or more biometric features of the first body part into a data structure.

### Example 83

This example includes any or all of the features of example 82, wherein the data structure is in the form of a database.

### Example 84

This example includes any or all of the features of any one of examples 69 and 70, wherein the instructions when executed further cause the system to perform the following operations including: supplementing the biometric reference template with supplemental biometric information.

### Example 85

This example includes any or all of the features of example 84, wherein the supplemental biometric information includes at least one biometric feature of a second body part of the user.

### Example 86

According to this example there is provided at least one computer readable medium for perform biometric authentication, including computer readable instructions which when executed by a processor of a biometric authentication system cause the system to perform the following operations including: generating a calibrated model of a first body part at least in part from depth information included in a depth image of the first body part acquired from a user with a depth sensor; extracting one or more biometric features of the first body part at least in part using the calibrated model to produce extracted biometric features; and comparing the extracted biometric features to biometric reference information in a biometric template; denying authentication of the user's identity when the extracted biometric features and the biometric reference information; and verifying the user's identity when the extracted biometric features and the biometric reference information.

### Example 87

This example includes any or all of the features of example 86, wherein the depth sensor includes a depth camera.

### Example 88

This example includes any or all of the features of any one of examples 86 and 87, wherein generating the calibrated model includes: formulating multiple hypotheses for a model of the first body part in a first position, each of the multiple hypotheses including a synthesized depth map of the first body part in the first position, wherein the first position corresponds to the position of the first body part when the depth frame is acquired; and identifying a best hypothesis from the multiple hypotheses at least in part by comparing the synthesized depth map of each of the multiple hypotheses to the depth information in the depth frame, the best hypothesis including one of the multiple hypotheses that most closely fits the depth information.

### Example 89

This example includes any or all of the features of example 88, wherein generating the calibrated model further includes: determining calibration parameters for the model of the first body part based at least in part on the best hypothesis; and adjusting the model of the first body part using the calibration parameters to produce the calibrated model, the calibrated model accurately modeling at least the skeletal geometry of the first body part.

### Example 90

This example includes any or all of the features of any one of examples 86 and 87, wherein the extracting includes: identifying a plurality of semantic points of the first body part using the calibrated model, wherein each of the semantic points correspond to a known feature of the first body part; identifying at least one selected semantic point from the plurality of semantic points; and determining the one or more biometric features of the first body part based at least in part on the at least one selected semantic point.

### Example 91

This example includes any or all of the features of example 90, wherein the determining includes measuring at least one biometric feature of the first body part from the depth information, the calibrated model, or a combination thereof based at least in part on the at least one selected semantic point.

### Example 92

This example includes any or all of the features of example 91, wherein the determining includes measuring at least one biometric feature of the first body part based at least in part on the depth information and the at least one selected semantic point.

### Example 93

This example includes any or all of the features of example 91, wherein the determining includes measuring at least one biometric feature of the first body part from the calibrated model and the at least one selected semantic point.

### Example 94

This example includes any or all of the features of example 90, wherein the first body part is a hand, and the one or more biometric features of the first body part comprise features of the hand.

### Example 95

This example includes any or all of the features of example 94, wherein the features of the hand comprise at least one of skeletal features of the hand, tissue features of the hand, surface features of the hand, or one or more combinations thereof.

### Example 96

This example includes any or all of the features of example 94, wherein the features of the hand include skeletal features of the hand, the skeletal features including one or more of a circumference of a knuckle of a joint of the hand, a length of a joint of the hand, a length of a finger bone of the hand, a length of a bone extending between two or more joints of a finger of the hand, or one or more combinations thereof.

### Example 97

This example includes any or all of the features of example 94, wherein the features of the hand comprise tissue features of the hand, and the tissue features comprise at least one of a skin thickness in at least one region of the hand, a blood vessel pattern of at least a portion of the hand, or a combination thereof.

### Example 98

This example includes any or all of the features of example 94, wherein the features of the hand comprise surface features of the hand, and the surface features comprise a palm print of the hand, a contour map of at least a portion of the hand, or a combination thereof.

### Example 99

This example includes any or all of the features of any one of examples 86 and 87, wherein the biometric template is in the form of a data structure including the biometric reference information.

### Example 100

This example includes any or all of the features of example 99, wherein the data structure is in the form of a database.

### Example 101

This example includes any or all of the features of any one of examples 86 and 87, wherein the instructions when executed further cause the system to perform the following operations including: comparing measured supplemental biometric information obtained from the user to supplemental biometric reference information previously obtained from the user; and denying authentication of the user's identity when at least one of the extracted biometric features or the measured supplemental biometric information does not substantially match the biometric reference information or the supplemental biometric reference information, respectively; and verifying the user's identity when the extracted biometric features and the measured supplemental biometric information substantially match the biometric reference information and the supplemental biometric reference information, respectively.

### Example 102

This example includes any or all of the features of example 101, wherein the supplemental biometric reference information includes at least one biometric feature previously determined from at least a second body part of the user, and the supplemental biometric reference information includes at least a measurement of the at least one biometric feature of the second body part.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1. A method for generating a biometric template, comprising:
generating a calibrated model of a first body part of a user at least in part from depth information included in a depth image of the first body part acquired with a depth sensor;
extracting one or more biometric features of said first body part at least in part using said calibrated model; and
producing a biometric reference template comprising said biometric features of said first body part as biometric reference information;
wherein generating said calibrated hand model comprises:
formulating multiple hypotheses for a model of said first body part in a first position, each of said multiple hypotheses comprising a depth map of the first body part in the first position, wherein the first position corresponds to the position of said first body part when said depth image is acquired; and
identifying a best hypothesis from said multiple hypotheses at least in part by comparing the depth map of each of said multiple hypotheses to the depth information in said depth image, the best hypothesis comprising one of said multiple hypotheses that most closely fits said depth information.

2. The method of claim 1, wherein said extracting comprises:
identifying a plurality of semantic points of the first body part using said calibrated model, wherein each of said semantic points correspond to a known feature of said first body part;
identifying at least one selected semantic point from said plurality of semantic points; and
determining said one or more biometric features of said first body part based at least in part on said at least one selected semantic point.

3. The method of claim 1, wherein said determining comprises measuring at least one biometric feature of said first body part from said depth information, said calibrated model, or a combination thereof based at least in part on said at least one selected semantic point.

4. The method of claim 3, wherein said determining comprises measuring at least one biometric feature of said first body part based at least in part on said depth information and said at least one selected semantic point.

5. The method of claim 3, wherein said determining comprises measuring at least one biometric feature of the first body part from the calibrated model and said at least one selected semantic point.

6. The method of claim 2, wherein said first body part is a hand, and said one or more biometric features of said first body part comprise features of said hand.

7. The method of claim 6, wherein said features of said hand comprise at least one of skeletal features of said hand, tissue features of said hand, surface features of said hand, or one or more combinations thereof.

8. The method of claim 1, wherein producing said biometric template comprises incorporating said one or more biometric features of said first body part into a data structure.

9. The method of claim 1, further comprising supplementing said one or more biometric features of said first body part with supplemental biometric information.

10. A method of performing biometric authentication, comprising:
generating a calibrated model of a first body part at least in part from depth information included in a depth image of the first body part acquired from a user with a depth sensor;
extracting one or more biometric features of said first body part at least in part using said calibrated model to produce extracted biometric features; and
comparing said extracted biometric features to biometric reference information in a biometric template;
denying authentication of the user's identity when said extracted biometric features and said biometric reference information do not substantially match; and
verifying the user's identity when said extracted biometric features and said biometric reference information substantially match;
wherein generating said calibrated model comprises:
formulating multiple hypotheses for a model of said first body part in a first position, each of said multiple hypotheses comprising a depth map of the first body part in the first position, wherein the first position corresponds to the position of said first body part when said depth image is acquired; and
identifying a best hypothesis from said multiple hypotheses at least in part by comparing the depth map of each of said multiple hypotheses to the depth information in said depth image, the best hypothesis comprising one of said multiple hypotheses that most closely fits said depth information.

11. The method of claim 10, wherein said extracting comprises:
identifying a plurality of semantic points of the first body part using said calibrated model, wherein each of said semantic points correspond to a known feature of said first body part;
identifying at least one selected semantic point from said plurality of semantic points; and
determining said one or more biometric features of said first body part based at least in part on said at least one selected semantic point.

12. The method of claim 10, wherein said determining comprises measuring at least one biometric feature of said first body part from said depth information, said calibrated model, or a combination thereof based at least in part on said at least one selected semantic point.

13. The method of claim 12, wherein said determining comprises measuring at least one biometric feature of said first body part based at least in part on said depth information and said at least one selected semantic point.

14. The method of claim 12, wherein said determining comprises measuring at least one biometric feature of the first body part from the calibrated model and said at least one selected semantic point.

15. The method of claim 12, wherein said first body part is a hand, and said one or more biometric features of said first body part comprise features of said hand.

16. The method of claim 15, wherein said features of said hand comprise at least one of skeletal features of said hand, tissue features of said hand, surface features of said hand, or one or more combinations thereof.

17. The method of claim 10, further comprising:
comparing measured supplemental biometric information obtained from the user to supplemental biometric reference information; and
denying authentication of the user's identity when at least one of said extracted biometric features or said measured supplemental biometric information does not substantially match said biometric reference information or said supplemental reference biometric information, respectively; and
verifying the user's identity when said extracted biometric features and said measured supplemental biometric information substantially match said biometric reference information and said supplemental reference biometric information, respectively.

18. A system for generating a biometric template, comprising logic implemented at least in part in hardware to cause the system to perform the following operations comprising:
generating a calibrated model of a first body part at least in part from depth information included in a depth image of the first body part acquired from a user with a depth sensor;
extracting one or more biometric features of said first body part at least in part using said calibrated model; and
producing a biometric reference template comprising said biometric features of said first body part as biometric reference information;
wherein generating said calibrated model comprises:
formulating multiple hypotheses for a model of said first body part in a first position, each of said multiple hypotheses comprising a depth map of the first body part in the first position, wherein the first position corresponds to the position of said first body part when said depth image is acquired; and
identifying a best hypothesis from said multiple hypotheses at least in part by comparing the depth map of each of said multiple hypotheses to the depth information in said depth image, the best hypothesis comprising one of said multiple hypotheses that most closely fits said depth information.

19. The system of claim 18, wherein said extracting comprises:
identifying a plurality of semantic points of the first body part using said calibrated model, wherein each of said semantic points correspond to a known feature of said first body part;
identifying at least one selected semantic point from said plurality of semantic points; and
determining said one or more biometric features of said first body part based at least in part on said at least one selected semantic point.

20. A system for performing biometric authentication, comprising logic implemented at least in part in hardware to cause the system to perform the following operations comprising:
generating a calibrated model of a first body part at least in part from depth information included in a depth image of the first body part acquired from a user with a depth sensor;
extracting one or more biometric features of said first body part at least in part using said calibrated model to produce extracted biometric features; and
comparing said extracted biometric features to a biometric template, the biometric template comprising biometric reference information;
denying authentication of the user's identity when said extracted biometric features and said biometric reference information do not substantially match; and
verifying the user's identity when said extracted biometric features and said biometric reference information substantially match;
wherein generating said calibrated model comprises:
formulating multiple hypotheses for a model of said first body part in a first position, each of said multiple hypotheses comprising a depth map of the first body part in the first position, wherein the first position corresponds to the position of said first body part when said depth image is acquired; and
identifying a best hypothesis from said multiple hypotheses at least in part by comparing the depth map of each of said multiple hypotheses to the depth information in said depth image, the best hypothesis comprising one of said multiple hypotheses that most closely fits said depth information.

21. The system of claim 20, wherein said extracting comprises:
identifying a plurality of semantic points of the first body part using said calibrated model, wherein each of said semantic points correspond to a known feature of said first body part;
identifying at least one selected semantic point from said plurality of semantic points; and
determining said one or more biometric features of said first body part based at least in part on said at least one selected semantic point.

22. At least one non-transitory computer readable medium comprising instructions for generating a biometric template, wherein said instructions when executed by a processor of a system for generating a biometric template cause the system to perform the following operations comprising:
generating a calibrated model of a first body part at least in part from depth information included in a depth image of the first body part acquired from a user with a depth sensor;
extracting one or more biometric features of said first body part at least in part using said calibrated model; and
producing a biometric reference template comprising said biometric features of said first body part as biometric reference information;
wherein generating said calibrated model comprises:
formulating multiple hypotheses for a model of said first body part in a first position, each of said multiple hypotheses comprising a depth map of the first body part in the first position, wherein the first position corresponds to the position of said first body part when said depth image is acquired; and
identifying a best hypothesis from said multiple hypotheses at least in part by comparing the depth map of each of said multiple hypotheses to the depth information in said depth image, the best hypothesis comprising one of said multiple hypotheses that most closely fits said depth information.

23. The at least one non-transitory computer readable medium of claim 22, wherein said extracting comprises:
identifying a plurality of semantic points of the first body part using said calibrated model, wherein each of said semantic points correspond to a known feature of said first body part;
identifying at least one selected semantic point from said plurality of semantic points; and
determining said one or more biometric features of said first body part based at least in part on said at least one selected semantic point.

24. At least one non-transitory computer readable medium for perform biometric authentication, comprising computer readable instructions which when executed by a processor of a biometric authentication system cause the system to perform the following operations comprising:
generating a calibrated model of a first body part at least in part from depth information included in a depth image of the first body part acquired from a user with a depth sensor;
extracting one or more biometric features of said first body part at least in part using said calibrated model to produce extracted biometric features; and
comparing said extracted biometric features to biometric reference information in a biometric template;
denying authentication of the user's identity when said extracted biometric features and said biometric reference information; and
verifying the user's identity when said extracted biometric features and said biometric reference information;
wherein generating said calibrated model comprises:
formulating multiple hypotheses for a model of said first body part in a first position, each of said multiple hypotheses comprising a depth map of the first body part in the first position, wherein the first position corresponds to the position of said first body part when said depth image is acquired; and
identifying a best hypothesis from said multiple hypotheses at least in part by comparing the depth map of each of said multiple hypotheses to the depth information in said depth image, the best hypothesis comprising one of said multiple hypotheses that most closely fits said depth information.

25. The at least one non-transitory computer readable medium of claim 24, wherein said extracting comprises:
identifying a plurality of semantic points of the first body part using said calibrated model, wherein each of said semantic points correspond to a known feature of said first body part;
identifying at least one selected semantic point from said plurality of semantic points; and
determining said one or more biometric features of said first body part based at least in part on said at least one selected semantic point.
